(19) United States
(12) Patent Application Publication
(10) Pub. No.: US 2010/0272334 A1
(43) Pub. Date: Oct. 28, 2010

(54) Microscope System, Specimen Observation Method, and Computer Program Product

(76) Inventors: Tatsuki Yamada, Tokyo (JP); Satoshi Arai, Tokyo (JP); Yoko Yamamoto, Tokyo (JP); Yuichi Ishikawa, Tokyo (JP); Kengo Takeuchi, Tokyo (JP)

Correspondence Address: GIBBONS P.C., ONE GATEWAY CENTER, NEWARK, NJ, 07102, US

(21) Appl. No.: 12/817,451

(22) Filed: Jun. 17, 2010

(30) Foreign Application Priority Data
Oct. 22, 1993 (JP) 05-264781
Aug. 24, 2006 (JP) 2006-228269
Feb. 28, 2007 (JP) 2007-049208
Jun. 18, 2009 (JP) 2009-145790

(51) Int. Cl. G06T 7/00

(52) U.S. Cl. 382/128

(57) ABSTRACT

A microscope system includes an image acquisition unit for acquiring a spectral image of a specimen by using a microscope, a structure specifying unit for specifying an extraction target structure in the specimen, a display method specifying unit for specifying a display method of the extraction target structure, a structure extraction unit for extracting an area of the extraction target structure in the spectral image by using a reference spectrum of the extraction target structure on the basis of pixel values of each pixel included in the spectral image, a display image generator for generating a display image that represents the extraction target structure in the specimen by the display method specified by the display method specifying unit on the basis of an extraction result of the structure extraction unit, and a display processing unit for performing process for displaying the display image on a display unit.

### CROSS-REFERENCE TO RELATED APPLICATIONS

This application is based upon and claims the benefit of priority from Japanese Patent Application No. 2009-145790, filed on Jun. 18, 2009, the entire contents of which are incorporated herein by reference.

### BACKGROUND OF THE INVENTION

1. Field of the Invention

The present invention relates to a microscope system, a specimen observation method, and a computer program product for acquiring a spectral image in which a specimen is imaged and observing the specimen by displaying the acquired spectral image.

2. Description of the Related Art

For example, in a pathological diagnosis, it is widely performed that a tissue sample obtained by organ harvesting or needle biopsy is thinly sliced to a thickness of several microns to create a specimen, and the specimen is magnified and observed by using an optical microscope to obtain various findings. Here, the specimen hardly absorbs or scatters light and is nearly clear and colorless, so that it is generally stained by dye before the observation.

While various types of staining methods are proposed, for example, so-called morphological observation staining is normally performed. The morphological observation staining is to observe morphology of the specimen, and stains cell nucleus, cytoplasm, connective tissue, and the like. According to the morphological observation staining, it is possible to grasp the size of elements constituting a tissue, the positional relationship between them, and the like, so that the state of the specimen can be determined morphologically. For example, as the morphological observation staining used in a tissue diagnosis, hematoxylin-eosin staining (hereinafter referred to as “HE staining”) that uses two types of dyes, hematoxylin and eosin, is widely known. On the other hand, in a cytological diagnosis, Papanicolaou staining (Pap staining) is typical. In this specification, staining that is normally performed in, for example, the morphological observation staining to observe a specimen is referred to as “standard staining”.

The observation of the stained specimen may be performed visually, but also may be performed by displaying the image of the specimen on a screen of a display device. For example, conventionally, it is performed that, by using a technique disclosed in Japanese Laid-open Patent Publication No. 07-120324, an image of an HE-stained specimen is captured by multiband imaging, by using a technique disclosed in Japanese Laid-open Patent Publication No. 2008-51654, an amount of dye that stains the specimen is calculated (estimated) by estimating a spectrum at a specimen position, and an RGB image to be displayed is synthesized.

Special staining which is performed along with the standard staining of the morphological observation staining is also known. The special staining is actively used for purposes such that to distinguishably stain specific structures such as an elastic fiber, a collagen fiber, and a smooth muscle included in a specimen to complement a diagnosis of a specimen on which the standard staining is performed, and to prevent abnormal findings from being overlooked. For example, Elastica van Gieson staining which selectively stains an elastic fiber or the like is performed to determine vessel invasion of cancer cells or the like. Masson trichrome staining which selectively stains a collagen fiber is performed to determine the degree of fibrosis in liver or the like. However, the special staining takes two to three days to perform the staining process, and thus there is a problem that the diagnosis cannot be performed quickly. In addition, working process of engineers increases when performing the special staining, so that there is a problem that the cost for producing a specimen increases. Thus, the special staining has been used for diagnosis in limited cases. Therefore, in diagnosis that uses a specimen on which only the standard staining is performed, diagnostic accuracy may decrease.

To solve such problems, approaches to identify a desired structure by image processing without using actual staining are proposed. For example, in Japanese Laid-open Patent Publication No. 2008-215820, a method for capturing a multi-spectrum image of a target object (specimen) to obtain spectral information of the specimen, and classifying tissue elements (structures) in the specimen on the basis of the obtained spectral information is disclosed.

### SUMMARY OF THE INVENTION

A microscope system according to an aspect of the present invention includes an image acquisition unit that acquires a spectral image of a specimen by using a microscope; a structure specifying unit that specifies an extraction target structure in the specimen; a display method specifying unit that specifies a display method of the extraction target structure; a structure extraction unit that extracts an area of the extraction target structure in the spectral image by using a reference spectrum of the extraction target structure on the basis of pixel values of each pixel included in the spectral image; a display image generator that generates a display image that represents the extraction target structure in the specimen by the display method specified by the display method specifying unit on the basis of an extraction result of the structure extraction unit; and a display processing unit that performs process for displaying the display image on a display unit.

A specimen observation method according to another aspect of the present invention includes acquiring a spectral image of a specimen by using a microscope; specifying a predetermined extraction target structure in the specimen; specifying a display method of the extraction target structure; extracting an area of the extraction target structure in the spectral image by using a reference spectrum of the extraction target structure on the basis of pixel values of each pixel included in the spectral image; generating a display image that represents the extraction target structure in the specimen by the specified display method on the basis of the extraction result; and displaying the display image.

A computer program product according to still another aspect of the present invention has a computer readable medium including programmed instructions. The instructions, when executed by a computer, cause the computer to perform instructing a microscope to operate and acquiring a spectral image of a specimen; specifying a predetermined extraction target structure in the specimen; specifying a display method of the extraction target structure; extracting an area of the extraction target structure in the spectral image by using a reference spectrum of the extraction target structure on the basis of pixel values of each pixel included in the spectral image; generating a display image that represents the extraction target structure in the specimen by the specified display method on the basis of the extraction result; and displaying the display image.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram for explaining an entire configuration example of a microscope system according to a first embodiment;

FIG. 2 is a schematic diagram for explaining a configuration of a filter unit;

FIG. 3 is a diagram showing a spectral transmittance characteristic of one optical filter;

FIG. 4 is a diagram showing a spectral transmittance characteristic of the other optical filter;

FIG. 5 is a diagram showing an example of spectral sensitivities of each of R, G, and B bands;

FIG. 6 is a flowchart showing an operation of the microscope system according to the first embodiment;

FIG. 7 is a diagram showing an example of a slide glass specimen;

FIG. 8 is a diagram showing an example of a specimen area image;

FIG. 9 is a diagram showing a data configuration example of a focus map;

FIG. 10 is a diagram for explaining a data configuration example of a VS image file according to the first embodiment;

FIG. 11 is another diagram for explaining the data configuration example of the VS image file according to the first embodiment;

FIG. 12 is a flowchart showing a processing procedure of VS image display process according to the first embodiment;

FIG. 13 is a diagram showing an example of a structure specifying screen;

FIG. 14 is a flowchart showing a detailed processing procedure of structure extraction process according to the first embodiment;

FIG. 15 is a diagram showing a data configuration example of an extraction target map;

FIG. 16 is a diagram showing an example of a VS image;

FIG. 17 is a diagram showing an example of a display image of the VS image in FIG. 16;

FIG. 18 is a diagram showing an image example of a specimen to which special staining is applied;

FIG. 19 is a diagram showing main functional blocks of a host system according to a second embodiment;

FIG. 20 is a flowchart showing a processing procedure of VS image display process according to the second embodiment;

FIG. 21 is a flowchart showing a detailed processing procedure of display image generation process according to the second embodiment;

FIG. 22 is a diagram showing an example of a LUT;

FIG. 23 is a diagram showing another example of the LUT;

FIG. 24 is a diagram showing main functional blocks of a host system according to a third embodiment;

FIG. 25 is a flowchart showing a processing procedure of VS image display process according to the third embodiment;

FIG. 26 is an illustration for explaining a modification principle of an extraction result of an extraction target structure;

FIG. 27 is another illustration for explaining the modification principle of an extraction result of an extraction target structure;

FIG. 28 is a diagram showing an example of a display image;

FIG. 29 is a diagram showing another example of a display image;

FIG. 30 is a diagram showing an example of an extraction target spectrum addition screen;

FIG. 31 is a diagram showing another example of the extraction target spectrum addition screen;

FIG. 32 is a flowchart showing a detailed processing procedure of non-display process according to a fourth embodiment;

FIG. 33 is a diagram showing main functional blocks of a host system according to a fifth embodiment;

FIG. 34 is a diagram showing a data configuration example of special staining definition information;

FIG. 35 is a diagram showing an example of a structure defined for Masson trichrome staining;

FIG. 36 is a diagram showing an example of a structure defined for Elastica van Gieson staining;

FIG. 37 is a flowchart showing a processing procedure of VS image display process according to the fifth embodiment;

FIG. 38 is a diagram showing an example of a special staining specifying screen;

FIG. 39 is a flowchart showing a detailed processing procedure of display image generation process according to the fifth embodiment;

FIG. 40 is a diagram showing main functional blocks of a host system according to a sixth embodiment; and

FIG. 41 is a flowchart showing a processing procedure of VS image display process according to the sixth embodiment.

### DETAILED DESCRIPTION OF THE PREFERRED EMBODIMENTS

Hereinafter, preferred embodiments of the present invention will be described in detail with reference to the drawings. The present invention is not limited to the embodiments. In the drawings, the same reference numerals are given to the same components.

When observing a specimen by using a microscope, an area (visual field) that can be observed at a time is determined by a magnification of an objective lens. Here, the higher the magnification of the objective lens is, the higher the resolution of an image that can be obtained, but the smaller the visual field is. To solve this type of problem, conventionally, an operation is performed in which an image with high resolution and large visual field is generated by capturing partial images of a specimen for each portion of the specimen by using a high resolution objective lens while moving a visual field by moving an electrically driven stage or the like on which the specimen is mounted, and combining the captured partial images (for example, refer to Japanese Laid-open Patent Publication Nos. 09-281405 and 2006-343573), and a system performing the above operation is called a virtual microscope system. Hereinafter, the image with high resolution and large visual field generated by the virtual microscope system is referred to as “VS image”.

According to the virtual microscope system, an observation can be performed even when there is no actual specimen. If the generated VS image is opened so that the VS image can be viewed via a network, the specimen can be observed regardless of time and place. Therefore, the virtual microscope system is used in a field of pathological diagnosis education or a consultation between pathologists distant from each other. Hereinafter, a case in which the present invention is applied to the virtual microscope system will be described as an example.

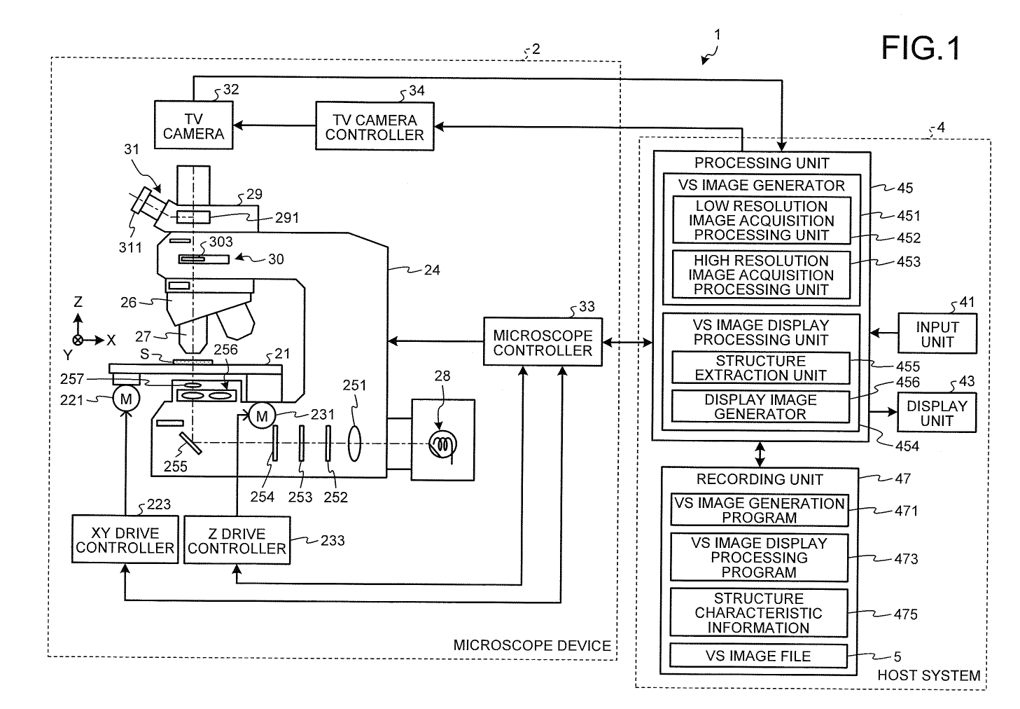

FIG. 1 is a schematic diagram for explaining an entire configuration example of a microscope system 1 according to a first embodiment. As shown in FIG. 1, the microscope system 1 is configured by connecting a microscope device 2 and a host system 4 so that data can be transmitted/received between them. FIG. 1 schematically shows a configuration of the microscope device 2, and also shows main functional blocks of the host system 4. Hereinafter, an optical axis direction of an objective lens 27 shown in FIG. 1 is defined as a Z direction, and a plane perpendicular to the Z direction is defined as an XY plane.

The microscope device 2 includes an electrically driven stage 21 on which a specimen S that is an observation/diagnosis target (hereinafter, referred to as “target specimen S”) is mounted and a microscope main body 24 which has an approximately squared U shape in a side view, supports the electrically driven stage 21, and holds the objective lens 27 via a revolver 26. Also, the microscope device 2 includes a light source 28 mounted in a bottom back portion (right portion in FIG. 1) of the microscope main body 24, and a lens barrel 29 mounted in an upper portion of the microscope main body 24. A binocular unit 31 for visually observing a specimen image of the target specimen S and a TV camera 32 for capturing the specimen image of the target specimen S are attached to the lens barrel 29.

Here, the target specimen S mounted on the electrically driven stage 21 is a specimen on which a standard staining is performed, and in the description below, a tissue specimen on which HE staining, which is one of staining methods for morphological observation, is performed will be used as an example. Specifically, the target specimen S is a specimen in which cell nuclei are stained bluish-purple by hematoxylin (hereinafter referred to “H dye”) and cytoplasms and connective tissues are stained pale red by eosin (hereinafter referred to “E dye”). The standard staining to be applied is not limited to the HE staining. For example, the present invention can be also applied to a specimen on which another staining method for morphological observation such as a Pap staining method is performed as the standard staining.

The electrically driven stage 21 is configured to be movable in the XYZ directions. Specifically, the electrically driven stage 21 can be moved in the XY plane by a motor 221 and an XY drive controller 223 that controls the drive of the motor 221. Under a control of a microscope controller 33, the XY drive controller 223 detects a predetermined origin position in the XY plane of the electrically driven stage 21 by an XY position origin sensor not shown in FIG. 1, and moves an observation point on the target specimen S by controlling a driving amount of the motor 221 by using the origin position as a base point. The XY drive controller 223 properly outputs an X position and a Y position of the electrically driven stage 21 during observation to the microscope controller 33. The electrically driven stage 21 can be moved in the Z direction by a motor 231 and a Z drive controller 233 that controls the drive of the motor 231. Under a control of the microscope controller 33, the Z drive controller 233 detects a predetermined origin position in the Z direction of the electrically driven stage 21 by a Z position origin sensor not shown in FIG. 1, and moves the target specimen S to an arbitrary Z position within a predetermined height range to focus the target specimen S by controlling a driving amount of the motor 231 by using the origin position as a base point. The Z drive controller 233 then properly outputs a Z position of the electrically driven stage 21 during observation to the microscope controller 33.

The revolver 26 is held rotatably to the microscope main body 24, and places the objective lens 27 over the target specimen S. The objective lens 27 is exchangably attached to the revolver 26 along with another objective lens having a different magnification (observation magnification), and only one objective lens 27 which is inserted in an optical path of an observation light to be used to observe the target specimen S is exclusively selected in accordance with rotation of the revolver 26. It is assumed that, in the first embodiment, the revolver 26 includes at least one objective lens with a relatively low magnification such as 2× or 4× magnification (hereinafter may be referred to as “low magnification objective lens”) and at least one objective lens with high magnification such as 10×, 20×, or 40× magnification (hereinafter may be referred to as “high magnification objective lens”) which is higher than that of the low magnification objective lens as the objective lenses 27. However, the low magnifications and the high magnifications as mentioned above are just an example, and only a magnification of one objective lens has to be higher than that of the other objective lens.

The microscope main body 24 internally includes an illumination optical system for transparently illuminating the target specimen S at a bottom portion thereof. The illumination optical system includes a collector lens 251 for collecting illumination light emitted from the light source 28, an illumination system filter unit 252, a field stop 253, an aperture stop 254, a folding mirror 255 for deflecting an optical path of the illumination light along the optical axis of the objective lens 27, a condenser optical element unit 256, and a top lens unit 257 which are arranged at appropriate positions along the optical path of the illumination light. The illumination light emitted from the light source 28 is irradiated to the target specimen S by the illumination optical system, and enters the objective lens 27 as the observation light.

The microscope main body 24 internally includes a filter unit 30 at an upper portion thereof. The filter unit 30 rotatably holds an optical filter 303 for limiting wavelength range of light formed into a specimen image within a predetermined range, and properly inserts the optical filter 303 into an optical path of the observation light in a post stage of the objective lens 27. The observation light passing through the objective lens 27 enters the lens barrel 29 via the filter unit 30.

The lens barrel 29 internally includes a beam splitter 291 for switching the optical path of the observation light passing through the filter unit 30 and guiding the optical path to the binocular unit 31 or the TV camera 32. The specimen image of the target specimen S is guided in the binocular unit 31 by the beam splitter 291 and visually observed by a microscope inspector via eyepieces 311. Or the specimen image is captured by the TV camera 32. The TV camera 32 includes an image sensor such as CCD or CMOS for forming the image of the specimen (specifically, visual field of the objective lens 27), captures the image of the specimen, and outputs image data of the image of the specimen to the host system 4.

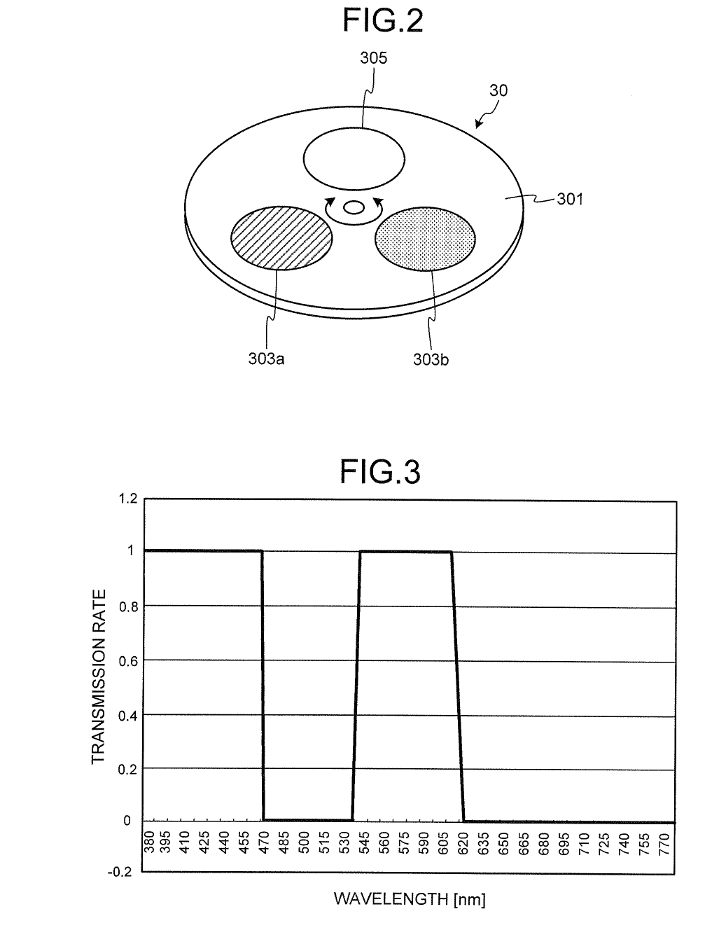

Here, the filter unit 30 will be described in detail. The filter unit 30 is used when performing multiband imaging of the specimen image by the TV camera 32. FIG. 2 is a schematic diagram for explaining a configuration of the filter unit 30. The filter unit 30 shown in FIG. 2 includes a rotating optical filter switching unit 301 in which, for example, three mounting holes for mounting optical elements are formed, two optical filters 303 (303a and 303b) having spectral transmittance characteristics different from each other are mounted in two out of the three mounting holes, and the remaining hole is configured to be an empty hole 305.

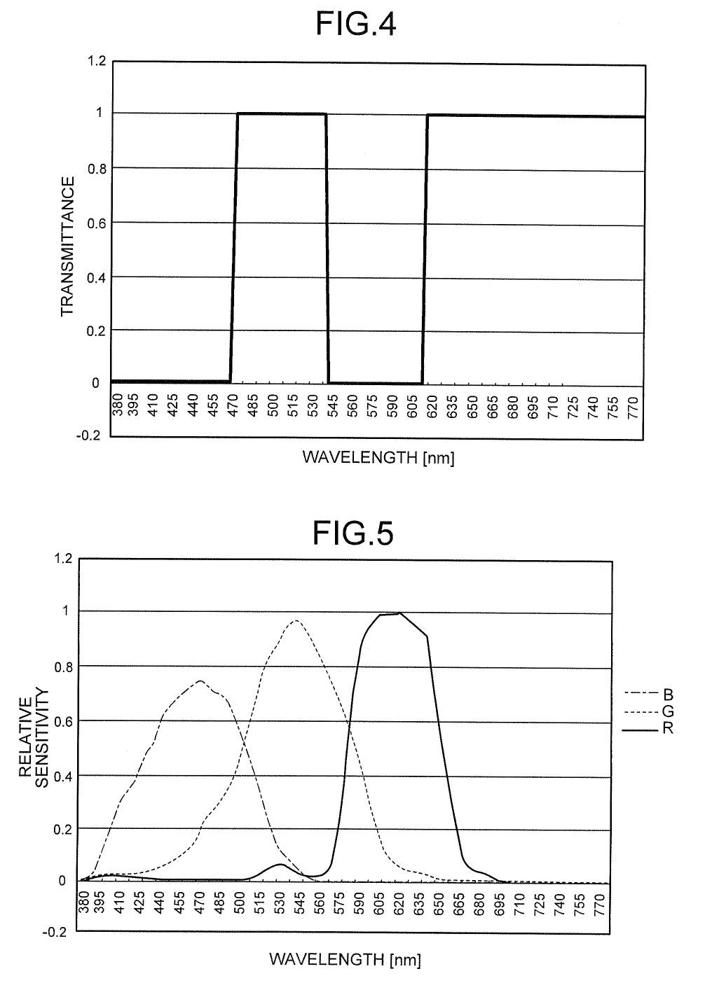

FIG. 3 is a diagram showing the spectral transmittance characteristic of one optical filter 303a, and FIG. 4 is a diagram showing the spectral transmittance characteristic of the other optical filter 303b. As shown in FIGS. 3 and 4, the optical filters 303a and 303b respectively have spectral characteristics dividing R, G, and B bands of the TV camera 32 into two bands. When performing multiband imaging of the target specimen S, first, the optical filter switching unit 301 is rotated to insert the optical filter 303a into the optical path of the observation light, and a first imaging of the specimen image is performed by the TV camera 32. Next, the optical filter switching unit 301 is rotated to insert the optical filter 303b into the optical path of the observation light, and a second imaging of the specimen image is performed by the TV camera 32. By the first imaging and the second imaging, a three-band image is respectively obtained, and a multiband image (spectral image) of six bands is obtained by combining the two images.

As described above, when performing multiband imaging of the specimen image by using the filter unit 30, the illumination light that is emitted from the light source 28 and irradiated to the target specimen S by the illumination optical system enters the objective lens 27 as the observation light. Thereafter, the light forms an image on the image sensor of the TV camera 32 via the optical filter 303a or the optical filter 303b. FIG. 5 is a diagram showing an example of spectral sensitivities of each of R, G, and B bands when capturing the specimen image by the TV camera 32.

When performing normal imaging (when capturing an RGB image of the specimen image), the optical filter switching unit 301 of FIG. 2 is rotated to place the empty hole 305 in the optical path of the observation light. Although, here, a case in which the optical filters 303a and 303b are arranged in a post stage of the objective lens 27 is described as an example, it is not limited to this, but the optical filters 303a and 303b may be arranged in any place in the optical path from the light source 28 to the TV camera 32. The number of the optical filters is not limited to two, but the filter unit may include three or more optical filters as necessary, and the number of the bands of the multiband image is not limited to six. For example, by using the technique disclosed in Japanese Laid-open Patent Publication No. 07-120324 described in Description of the Related Art, a 16-band multiband image may be captured by capturing a multiband image using a frame sequential method while switching 16 band-pass filters. The method for capturing a multiband image is not limited to the method in which the optical filters are switched. For example, a plurality of TV cameras is prepared. Then, the observation light is guided to each TV camera via a beam splitter or the like, and an imaging optical system in which spectral characteristics are complemented to each other may be configured. Based on this, it is possible to capture the specimen images by the TV cameras at the same time and obtain a multiband image at one time by combining the captured images, so that the process can be speeded up.

As shown in FIG. 1, the microscope device 2 includes the microscope controller 33 and a TV camera controller 34. The microscope controller 33 integrally controls operations of each component constituting the microscope device 2 under control of the host system 4. For example, the microscope controller 33 performs adjustments of each component of the microscope device 2 when the observation of the target specimen S is carried out, such as switching the objective lens 27 placed in the optical path of the observation light by rotating the revolver 26, controlling a light amount of the light source 28 and switching various optical elements according to the magnification and the like of the switched objective lens 27, and instructing the XY drive controller 223 and the Z drive controller 233 to move the electrically driven stage 21, and appropriately notifies the host system 4 of states of each component. The TV camera controller 34 drives the TV camera 32 and controls the image capturing operation of the TV camera 32 by performing on/off switching of automatic gain control, setting gain, on/off switching of automatic exposure control, setting exposure time, and the like under the control of the host system 4.

Meanwhile, the host system 4 includes an input unit 41, a display unit 43, a processing unit 45, a recording unit 47, and the like.

The input unit 41 is realized by, for example, a keyboard, a mouse, a touch panel, various switches, and the like, and outputs an operation signal responding to an operational input to the processing unit 45. The display unit 43 is realized by a display device such as an LCD or an EL display, and displays various screens on the basis of a display signal inputted from the processing unit 45.

The processing unit 45 is realized by hardware such as a CPU. The processing unit 45 integrally controls operations of the entire microscope system 1 by transmitting instructions and data to each component constituting the host system 4 and transmitting instructions to the microscope controller 33 and the TV camera controller 34 to operate each component of the microscope device 2 on the basis of an input signal inputted from the input unit 41, the states of each component of the microscope device 2 inputted from the microscope controller 33, the image data inputted from the TV camera 32, a program and data recorded in the recording unit 47, and the like. For example, the processing unit 45 performs AF (Auto Focus) processing to detects a focus position (focal position) where the image is focused by evaluating the contrast of the image at each Z position on the basis of the image data inputted from the TV camera 32 while moving the electrically driven stage 21 in the Z direction. The processing unit 45 performs compression process or decompression process based on a compression method such as JPEG and JPEG2000 when recording or displaying the image data inputted from the TV camera 32 to the recording unit 47 or the display unit 43. The processing unit 45 includes a VS image generator 451 and a VS image display processing unit 454 as a display processing unit.

The VS image generator 451 obtains a low resolution image and a high resolution image of the specimen image and generates a VS image. Here, the VS image is an image in which one or more images captured by the microscope device 2 are combined and generated. Hereinafter, an image, which is generated by combining a plurality of high resolution images which are partial images of the target specimen S captured by using the high magnification objective lens, and is a wide view and high resolution multiband image covering the entire area of the target specimen S, is referred to as the VS image.

The VS image generator 451 includes a low resolution image acquisition processing unit 452 and a high resolution image acquisition processing unit 453 as an image acquisition unit and a spectrum image generator. The low resolution image acquisition processing unit 452 issues operation instructions to each component of the microscope device 2 and acquires a low resolution image of the specimen image. The high resolution image acquisition processing unit 453 issues operation instructions to each component of the microscope device 2 and acquires a high resolution image of the specimen image. Here, the low resolution image is acquired as an RGB image by using the low magnification objective lens to observe the target specimen S. On the other hand, the high resolution image is acquired as a multiband image by using the high magnification objective lens to observe the target specimen S.

The VS image display processing unit 454 extracts an area of a predetermined structure from the VS image, and performs process for displaying a display image which represents the structure in the target specimen S on the basis of the extraction result in accordance with a predetermined display method on the display unit 43. The VS image display processing unit 454 includes a structure extraction unit 455 and a display image generator 456. The structure extraction unit 455 performs image processing on the VS image, and extracts an area covering an extraction target structure (hereinafter also referred to as “extraction target structure”) specified by a user such as a pathologist from the VS image. The display image generator 456 generates a display image which represents the extraction target structure in the target specimen S appearing in the VS image using a display method specified by the user. As the display method, two types of the display methods such as “highlighted display” and “non-display” are prepared. The “highlighted display” is a display method for highlighting the area of the extraction target structure while the other areas are not highlighted. The “non-display” is a display method for not displaying the extraction target structure. In the first embodiment, a case in which the “highlighted display” is specified as the display method will be described.

The recording unit 47 is realized by a various IC memories such as a ROM including a flash memory that can be updated and a RAM, and storage media such as a hard disk and a CD-ROM that are installed inside the host system 4 or connected via a data communication terminal and reading devices thereof. In the recording unit 47, a program for operating the host system 4 and realizing various functions included in the host system 4, data used while the program is being executed, and the like are recorded.

In the recording unit 47, a VS image generation program 471 for causing the processing unit 45 to function as the VS image generator 451 and realizing VS image generation process, and a VS image display processing program 473 for causing the processing unit 45 to function as the VS image display processing unit 454 and realizing VS image display process are recorded. The recording unit 47 stores structure characteristic information 475 as a spectral characteristic recording unit. Further, a VS image file 5 is recorded in the recording unit 47. The details of the structure characteristic information 475 and the VS image file 5 will be described below.

The host system 4 can be realized by a publicly known hardware configuration including a CPU, a video board, a main storage device such as a main memory, an external storage device such as a hard disk and various storage media, a communication device, an output device such as a display device and a printing device, an input device, an interface device for connecting each unit or connecting an external input, and the like, and for example a general purpose computer such as a workstation and a personal computer can be used as the host system 4.

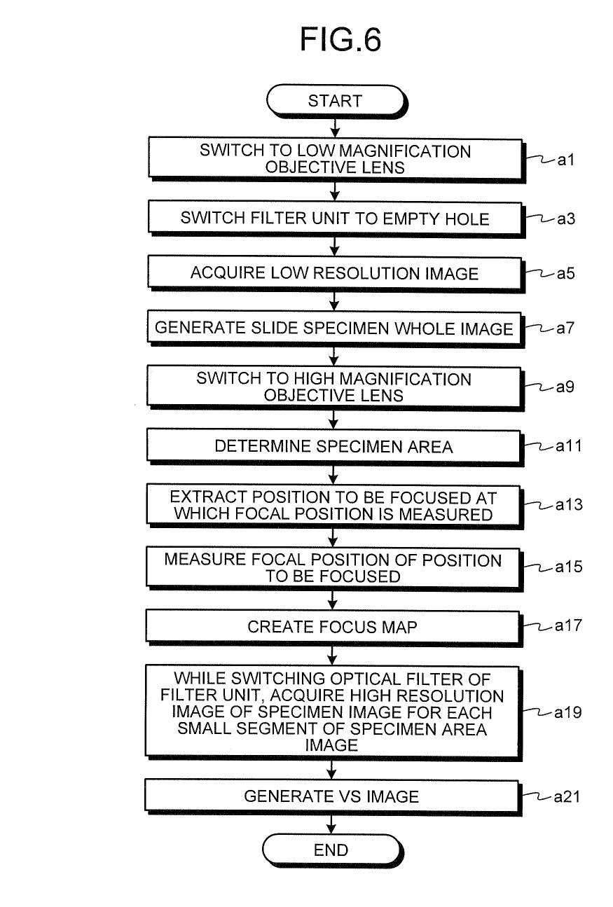

Next, the VS image generation process and the VS image display process according to the first embodiment will be described in this order. First, the VS image generation process will be described. FIG. 6 is a flowchart showing an operation of the microscope system 1 realized by the processing unit 45 of the host system 4 performing the VS image generation process. The operation of the microscope system 1 described here is realized by the VS image generator 451 reading and executing the VS image generation program 471 recorded in the recording unit 47.

As shown in FIG. 6, first, the low resolution image acquisition processing unit 452 of the VS image generator 451 outputs an instruction for switching the objective lens 27 used to observe the target specimen S to the low magnification objective lens to the microscope controller 33 (step a1). Responding to this, the microscope controller 33 rotates the revolver 26 as necessary and places the low magnification objective lens in the optical path of the observation light.

Next, the low resolution image acquisition processing unit 452 outputs an instruction for switching the filter unit 30 to the empty hole 305 to the microscope controller 33 (step a3). Responding to this, the microscope controller 33 rotates the optical filter switching unit 301 of the filter unit 30 as necessary and places the empty hole 305 in the optical path of the observation light.

Next, the low resolution image acquisition processing unit 452 issues operation instructions to operate each component of the microscope device 2 to the microscope controller 33, and the TV camera controller 34 and acquires a low resolution image (RGB image) of the specimen image (step a5).

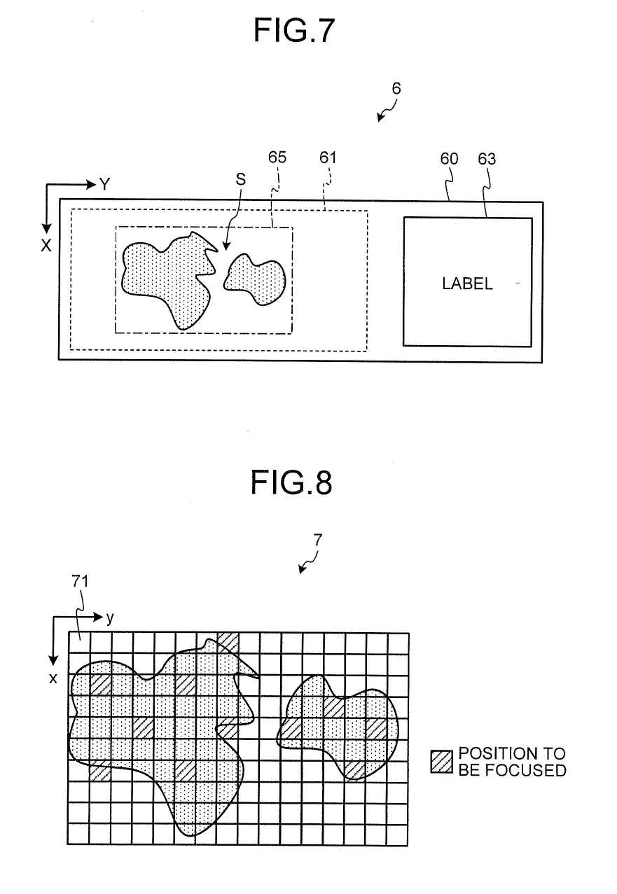

FIG. 7 is a diagram showing an example of a slide glass specimen 6. Actually, the target specimen S on the electrically driven stage 21 shown in FIG. 1 is mounted on the electrically driven stage 21 as the slide glass specimen 6 in which the target specimen S is mounted on a slide glass 60 as shown in FIG. 7. The target specimen S is mounted in a specimen search range 61 that is a predetermined area on the slide glass 60 (for example, an area of height: 25 mm×width: 50 mm in the left side of the slide glass 60 in FIG. 7). A label 63 on which information related to the target specimen S mounted on the specimen search range 61 is written is attached to a predetermined area on the slide glass 60 (for example, an area on the right side of the specimen search range 61). For example, a barcode, which is formed by encoding a slide specimen number that is identification information for identifying the target specimen S in accordance with a predetermined specification, is printed on the label 63, and the barcode is read by a barcode reader (not shown in the figures) included in the microscope system 1.

Responding to the operation instruction issued by the low resolution image acquisition processing unit 452 in step a5 in FIG. 6, the microscope device 2 captures an image of the specimen search range 61 on the slide glass 60 shown in FIG. 7. Specifically, the microscope device 2 divides the specimen search range 61 on the basis of the size of visual field determined in accordance with the magnification of the low magnification objective lens switched in step a1 (in other words, on the basis of the image capturing range of the TV camera 32 when using the low magnification objective lens to observe the target specimen S), and sequentially captures the specimen image of the specimen search range 61 for each divided section by the TV camera 32 while moving the electrically driven stage 21 in the XY plane according to the size of the divided section. The image data captured here is outputted to the host system 4, and is acquired by the low resolution image acquisition processing unit 452 as the low resolution image of the specimen image.

As shown in FIG. 6, the low resolution image acquisition processing unit 452 then combines the low resolution images of each divided section acquired in step a5, and generates one image covering the specimen search range 61 in FIG. 7 as a slide specimen whole image (step a7).

Next, the high resolution image acquisition processing unit 453 outputs an instruction for switching the objective lens 27 used to observe the target specimen S to the high magnification objective lens to the microscope controller 33 (step a9). Responding to this, the microscope controller 33 rotates the revolver 26 and places the high magnification objective lens in the optical path of the observation light.

Next, the high resolution image acquisition processing unit 453 automatically extracts and determines a specimen area 65 where the target specimen S is actually mounted in the specimen search range 61 in FIG. 7 on the basis of the slide specimen whole image generated in step a7 (step all). The automatic extraction of the specimen area can be performed by appropriately employing a publicly known method. For example, the presence or absence of the specimen is determined for each pixel by binarizing each pixel in the slide specimen whole image, and a rectangular area enclosing a range of pixels determined to be pixels reflecting the target specimen S is determined to be the specimen area. It is also possible to receive a selection operation of the specimen area by a user through the input unit 41, and determine the specimen area according to the operation input.

Next, the high resolution image acquisition processing unit 453 cuts out an image of the specimen area (specimen area image) determined in step all from the slide specimen whole image, and selects a position at which the focal position is measured from the specimen area image to extract the position to be focused (step a13).

FIG. 8 is a diagram showing an example of a specimen area image 7 cut out from the slide specimen whole image, and FIG. 8 shows an image of the specimen area 65 in FIG. 7. First, as shown in FIG. 8, the high resolution image acquisition processing unit 453 divides the specimen area image 7 into a grid-like pattern, and forms a plurality of small segments. Here, the segment size of the small segment corresponds to the size of the visual field determined according to the magnification of the high magnification objective lens switched in step a9 (in other words, the size of the image capturing range of the TV camera 32 when using the high magnification objective lens to observe the target specimen S).

Next, the high resolution image acquisition processing unit 453 selects a small segment used as the position to be focused from the plurality of small segments having been formed. This is because if the focal point is measured for every small segment, the processing time increases. Therefore, for example, a predetermined number of small segments are randomly selected from the small segments. Or, the small segments used as the position to be focused may be selected in accordance with a predetermined rule, such as, a small segment used as the position to be focused is selected from every predetermined number of small segments. When the number of the small segments is small, all the small segments may be selected as the position to be focused. The high resolution image acquisition processing unit 453 calculates the center coordinates of the selected small segment in the coordinates system (x, y) of the specimen area image 7, and converts the calculated center coordinates into the coordinate system (X, Y) of the electrically driven stage 21 of the microscope device 2 to obtain the position to be focused. The coordinate conversion is performed on the basis of the magnification of the objective lens 27 used to observe the target specimen S, the number of pixels and the pixel size of the image sensor included in the TV camera 32, or the like, and for example, can be realized by applying the publicly known technique described in Japanese Laid-open Patent Publication No. 09-281405.

Next, as shown in FIG. 6, the high resolution image acquisition processing unit 453 issues instructions to operate each component of the microscope device 2 to the microscope controller 33 and the TV camera controller 34 and measures the focal position of the position to be focused (step a15). At this time, the high resolution image acquisition processing unit 453 outputs the extracted positions to be focused to the microscope controller 33. Responding to this, the microscope device 2 moves the electrically driven stage 21 in the XY plane, and sequentially moves the positions to be focused to the optical axis position of the objective lens 27. The microscope device 2 then obtains image data at the position to be focused by the TV camera 32 while moving the electrically driven stage 21 in the Z direction at each position to be focused. The obtained image data is outputted to the host system 4, and acquired by the high resolution image acquisition processing unit 453. The high resolution image acquisition processing unit 453 evaluates the contrast of the image data at each Z position, and measures the focal position (Z position) of the target specimen S at each position to be focused.

After measuring the focal positions at each position to be focused as described above, the high resolution image acquisition processing unit 453 creates a focus map on the basis of the measurement result of the focal positions at each position to be focused and records the focus map to the recording unit 47 (step a17). Specifically, the high resolution image acquisition processing unit 453 sets the focal positions for all the small segments by interpolating focal positions of small segments not extracted as the position to be focused in step a13 by using nearby focal positions of the position to be focused, and creates the focus map.

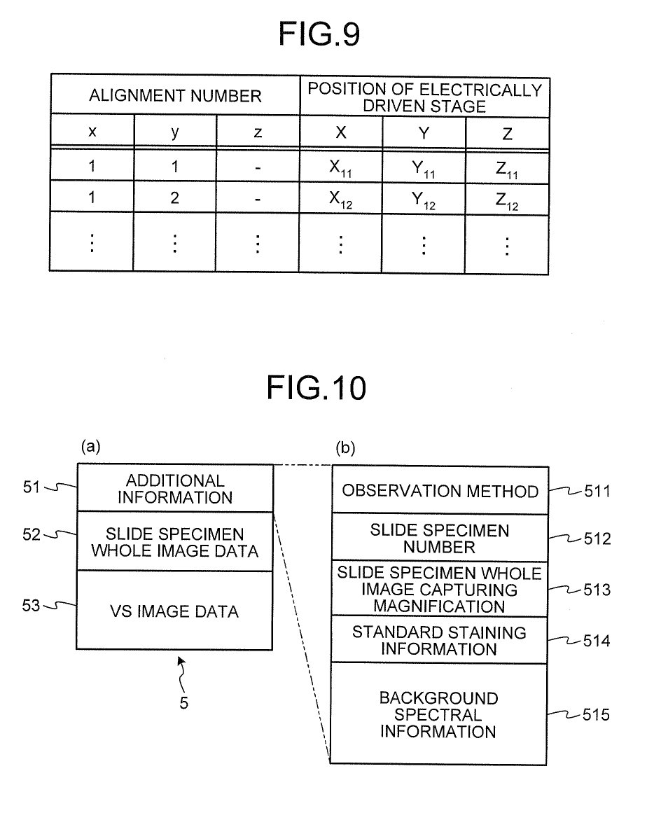

FIG. 9 is a diagram showing a data configuration example of the focus map. As shown in FIG. 9, the focus map is a data table in which alignment numbers and positions of the electrically driven stage are associated with each other. The alignment numbers indicate each small segment in the specimen area image 7 shown in FIG. 8. Specifically, the alignment number represented by x is a serial number sequentially given to each column along the x direction starting from the left end to which the first number is given, and the alignment number represented by y is a serial number sequentially given to each row along the y direction starting from the uppermost row to which the first number is given. The alignment number represented by z is a value set when generating the VS image as a three-dimensional image. The positions of the electrically driven stage are positions of X, Y, and Z of the electrically driven stage 21 which are set as the focal position of the small segment of the specimen area image indicated by corresponding alignment numbers. For example, the alignment number of (x, y, z)=(1, 1, -) indicates a small segment 71 in FIG. 8, and the X position and the Y position, which are obtained by converting the center coordinates of the small segment 71 in the coordinate system (x, y) into the coordinate system (X, Y) of the electrically driven stage 21, correspond to X₁₁ and Y₁₁ respectively. The focal position (Z position) set for the small segment corresponds to Z₁₁.

Next, as shown in FIG. 6, the high resolution image acquisition processing unit 453 sequentially outputs instructions for switching the filter unit 30 to the optical filters 303a and 303b to the microscope controller 33. Along with the above operation, while referring to the focus map, the high resolution image acquisition processing unit 453 issues instructions to operate each component of the microscope device 2 to the microscope controller 33 and the TV camera controller 34, captures the specimen image for each small segment of the specimen area image by multiband imaging, and acquires a high resolution image (hereinafter may be referred to as “specimen area segment image”) (step a19).

Responding to this, the microscope device 2 rotates the optical filter switching unit 301 of the filter unit 30, and first, sequentially captures the specimen image for each small segment of the specimen area image at the focal position thereof by the TV camera 32 while moving the electrically driven stage 21 with the optical filter 303a being placed in the optical path of the observation light. Next, the optical filter 303a is switched to the optical filter 303b and the optical filter 303b is placed in the optical path of the observation light, and thereafter the microscope device 2 captures the specimen image for each small segment of the specimen area image in the same way as described above. The image data captured here is outputted to the host system 4, and the image data is acquired by the high resolution image acquisition processing unit 453 as the high resolution image of the specimen image (specimen area segment image).

Next, the high resolution image acquisition processing unit 453 combines the specimen area segment images which are the high resolution images acquired in step a19, and generates one image covering the entire area of the specimen area 65 in FIG. 7 as the VS image (step a21).

In the above steps a13 to a21, the specimen area image is divided into small segments corresponding to the visual field of the high magnification objective lens. The specimen area segment images are acquired by capturing the specimen image for each small segment, and the VS image is generated by combining the specimen area segment images. On the other hand, the small segments may be set so that the specimen area segment images next to each other partially overlap each other at the border therebetween. And, one VS image may be generated by combining the specimen area segment images so that the positional relationship between the specimen area segment images next to each other is adjusted. Specific processing can be realized by applying publicly known techniques described in Japanese Laid-open Patent Publication Nos. 09-281405 and 2006-343573, and in this case, the segment size of the small segment is set to a size smaller than the visual field of the high magnification objective lens so that edge portions of acquired specimen area segment images overlap each other between the specimen area segment images next to each other. In this way, even when the accuracy of movement control of the electrically driven stage 21 is low and the specimen area segment images next to each other are not connected continuously, a VS image in which connection portions are continuously connected by the overlapping portions can be generated.

As a result of the VS image generation process described above, a wide view and high resolution multiband image covering the entire area of the target specimen S can be acquired. Here, the processes of step a1 to step a21 is performed automatically. Therefore, a user only has to mount the target specimen S (specifically, the slide glass specimen 6 in FIG. 7) on the electrically driven stage 21, and input a start instruction operation of the VS image generation process via the input unit 41. The processes may be interrupted as necessary at any of steps a1 to a21, and a user operation may be inputted. For example, process for changing the high magnification objective lens to be used to another objective lens with different magnification in accordance with an operation input after step a9, process for changing the determined specimen area in accordance with an operation input after step all, process for changing, adding, or deleting the extracted position to be focused in accordance with an operation input after step a13, and the like may be performed as necessary.

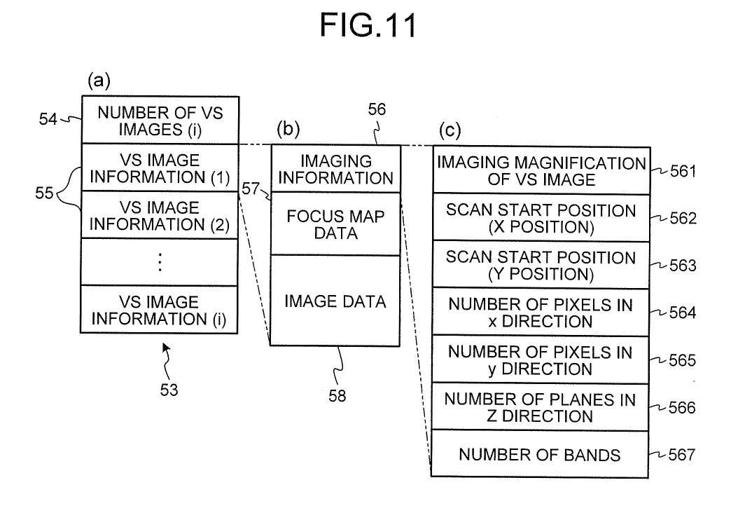

FIGS. 10 and 11 are diagrams for explaining a data configuration example of a VS image file 5 acquired as a result of the VS image generation process and recorded in the recording unit 47. As shown in (a) of FIG. 10, the VS image file 5 includes additional information 51, slide specimen whole image data 52, and VS image data 53.

As shown in (b) of FIG. 10, in the additional information 51, an observation method 511, a slide specimen number 512, a slide specimen whole image capturing magnification 513, standard staining information 514, background spectral information 515, and the like are set.

The observation method 511 is an observation method of the microscope device 2 used to generate the VS image, and for example “bright field observation method” is set in the first embodiment. When a microscope device in which a specimen can be observed by another observation method such as dark field observation, fluorescence observation, differential interference observation, and the like is used, the observation method used when the VS image is generated is set.

In the slide specimen number 512, for example, a slide specimen number read from the label 63 of the slide glass specimen 6 shown in FIG. 7 is set. The slide specimen number is, for example, an ID uniquely assigned to the slide glass specimen 6, and the target specimen S can be identified by the ID. In the slide specimen whole image capturing magnification 513, the magnification of the low magnification objective lens used when the slide specimen whole image is acquired is set. The slide specimen whole image data 52 is image data of the slide specimen whole image.

In the standard staining information 514, a type of standard staining performed on the target specimen S is set. Specifically, although the HE staining is set in the first embodiment, the standard staining information 514 is set when a user manually inputs and specifies a type of standard staining performed on the target specimen S in a process of the VS image display process described below.

The background spectral information 515 records spectral data in the background of the target specimen S. For example, an area not including the target specimen S in the VS image acquired by performing multiband imaging of the specimen search range 61 shown in FIG. 7 is defined as the background, and pixel values for each band in the background are recorded as the background spectral information 515.

In the VS image data 53, various information related to the VS image is set. Specifically, as shown in (a) of FIG. 11, the VS image data 53 includes the number of VS images 54 and VS image information 55 (1) to (i), the number of which corresponds to the number of VS images 54. The number of VS images 54 is the number of VS image information 55 recorded in the VS image data 53, and corresponds to i. Regarding the data configuration example of the VS image data 53 shown in (a) of FIG. 11, it is assumed a case that a plurality of VS images is generated from one specimen. Although, in the example described above and shown in FIG. 7, the slide glass specimen 6 in which one specimen area 65 is extracted as an area where the target specimen S is actually mounted is described, there are slide glass specimens in which a plurality of specimens are placed separately. In this case, it is not necessary to create the VS image of an area not including a specimen. Therefore, when a plurality of specimens is placed separately from each other by a certain distance, an area of each specimen placed separately is extracted individually, and the VS image is generated for each area of the extracted specimens. The number of VS images generated at this time is set as the number of VS images 54. Various information related to each VS image is set as the VS image information 55 (1) to (i). In the example of FIG. 7, although two specimen areas are included in the specimen area 65, the two specimen areas are extracted as one specimen area 65 because the distance between the two specimen areas is small. In each VS image information 55, as shown in (b) of FIG. 11, imaging information 56, focus map data 57, image data 58, and the like are set.

In the imaging information 56, as shown in (c) of FIG. 11, an imaging magnification of VS image 561, a scan start position (X position) 562, a scan start position (Y position) 563, the number of pixels in the x direction 564, the number of pixels in the y direction 565, the number of planes in the Z direction 566, the number of bands 567, and the like are set.

In the imaging magnification of VS image 561, the magnification of the high magnification objective lens used when the VS image is acquired is set. The scan start position (X position) 562, the scan start position (Y position) 563, the number of pixels in the x direction 564, and the number of pixels in the y direction 565 indicate an image capturing range of the VS image. Specifically, the scan start position (X position) 562 is the X position of the scan start position of the electrically driven stage 21 when the image capturing of the specimen area segment images constituting the VS image is started, and the scan start position (Y position) 563 is the Y position from which the scan is started. The number of pixels in the x direction 564 is the number of pixels of the VS image in the x direction, the number of pixels in the y direction 565 is the number of pixels of the VS image in the y direction, and both numbers indicate the size of the VS image.

The number of planes in the Z direction 566 corresponds to the number of sectioning levels in the Z direction, and when generating the VS image as a three-dimensional image, the number of imaging planes in the Z direction is set in the number of planes in the Z direction 566. Hereinafter, “1” is set in the number of planes in the Z direction 566. The VS image is generated as a multiband image. The number of bands of the multiband image is set in the number of bands 567, and “6” is set in the first embodiment.

The focus map data 57 shown in (b) of FIG. 11 is data of the focus map shown in FIG. 9. The image data 58 is image data of the VS image, and raw data of 6 bands (pixel values of pixels for each band constituting the VS image) is set in the image data 58.

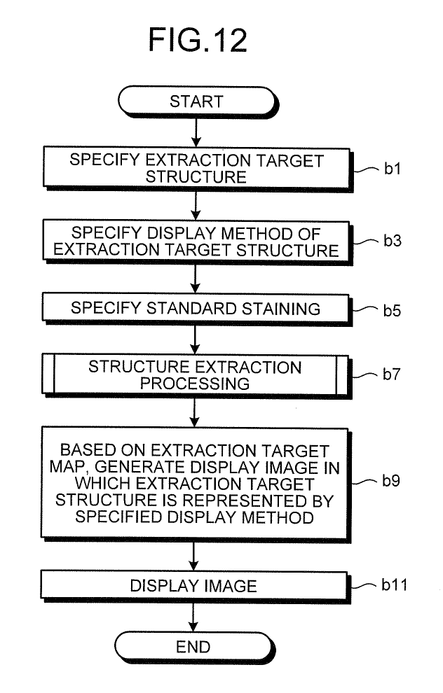

Next, the VS image display process will be described. FIG. 12 is a flowchart showing a processing procedure of the VS image display process according to the first embodiment. The processing described here is realized by the VS image display processing unit 454 reading and executing the VS image display processing program 473 recorded in the recording unit 47.

As shown in FIG. 12, first, in accordance with a user operation, the VS image display processing unit 454 specifies a type of the extraction target structure as a structure specifying unit (step b1), and specifies a display method of the extraction target structure as a display method specifying unit (step b3). At this time, the VS image display processing unit 454 specifies a display color or a check color along with the display method in accordance with a user operation. Also, the VS image display processing unit 454 specifies a type of the standard staining performed on the target specimen S in accordance with a user operation (step b5). For example, the VS image display processing unit 454 performs process for displaying a structure specifying screen on the display unit 43 and notifying of a specification request related to the extraction target structure and the display thereof, and receives a specification operation of the extraction target structure, the display method thereof, and the standard staining on the structure specifying screen.

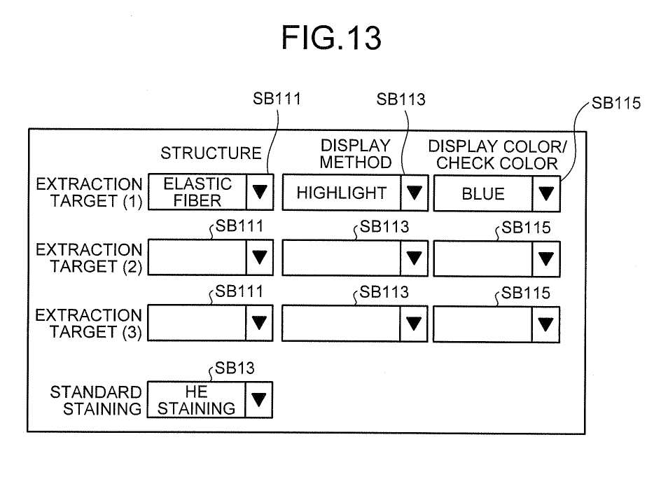

FIG. 13 is a diagram showing an example of the structure specifying screen. As shown in FIG. 13, in the structure specifying screen, three sets of a spin box SB111 for specifying the extraction target structure, a spin box SB113 for specifying the display method, and a spin box SB115 for specifying the display color/check color are arranged, and three types of structures can be specified as the extraction target structures. The number of the structures mentioned above is an example, and one or two types of extraction target structures may be specified, or four or more types of extraction target structures may be specified.

The spin box SB111 presents a list of structures that can be specified as the extraction target structure as options, and prompts to specify an extraction target structure. The structures to be presented include a collagen fiber, an elastic fiber, a smooth muscle, and the like. However, the structures are not limited to the exemplified structures, but can be set as necessary. The spin box SB113 presents “highlight” or “non-display”as an option, and prompts to specify the display method.

The spin box SB115 presents a list of colors prepared in advance as the display color/check color as options, and prompts to specify a display color or a check color. Specifically, for example, when the “highlight” is specified in the spin box SB113 of the corresponding display method, the display color during the highlight is specified in the spin box SB115. On the other hand, when the “non-display” is specified in the spin box SB113 of the corresponding display method, the check color of the non-display is specified in the spin box SB115. Here, the check color is a display color when displaying and checking an area of the extraction target structure extracted from the VS image. Specifically, as explained in a fourth embodiment described below, when the “non-display” is specified as the display method, a display image in which the extraction target structure is not displayed is generated. However, in order to check detection error or the like, the extraction result is displayed temporarily to present to a user. When the user specifies the “non-display” in the spin box SB113, the user specifies the check color, which is the display color of the extraction target structure at this time, in the spin box SB115. The colors prepared as the display color/check color are not particularly limited, and for example, colors such as “brown”, “green”, “black”, and the like may be set as necessary.

In the structure specifying screen, a spin box SB13 for specifying the type of the standard staining that actually stains the target specimen S is arranged. The spin box SB13 presents a list of the standard staining as options, and prompts to specify the type of the standard staining. The standard staining to be presented includes, for example, HE staining and Pap staining which are morphological observation staining. However, the staining is not limited to the exemplified morphological observation staining, but can be set as necessary.

In the structure specifying screen, for example, a user specifies a desired structure as the extraction target structure in the uppermost spin box SB111, specifies the display method in the corresponding spin box SB113, and specifies the display color or the check color in the corresponding spin box SB115. When there are two or more structures desired to be extracted, they are specified in the lower spin boxes SB111, SB113, and SB115. In the spin box SB13, the standard staining performed on the target specimen S is specified. The specified type of the extraction target structure, the display method thereof, the display color/check color, and the type of the standard staining are recorded in the recording unit 47, and used in later process. In the above information, the type of the standard staining is set in the VS image file 5 as the standard staining information 514 (refer to FIG. 10).

Next, as shown in FIG. 12, the structure extraction unit 455 performs structure extraction process (step b7). In the structure extraction process, characteristic information of the extraction target structure recorded in the recording unit 47 as the structure characteristic information 475 is used as a reference spectrum (teacher data), an area covering the specified type of extraction target structure is extracted from the VS image of the target specimen S generated in the VS image generation process, and an extraction target map is generated. The structure characteristic information 475 is an example of spectral characteristic information, and predefined characteristic information is recorded for each structure that can be specified as the extraction target structure.

Here, the definition of the structure will be described. Before the definition of the structure, one or more specimens including the structure are prepared in advance, and a plurality (N) of spectral data is measured. Specifically, for example, the prepared specimens are imaged by multiband imaging in the microscope system 1. Then, for example, by selecting N pixel positions from an area covering the structure in accordance with a user operation, measurement values for each wavelength λ (pixel values for each band at the selected pixel positions) are obtained.

As a data space for defining the characteristic of the structure, an absorbance space formed by converting the measurement values for each wavelength λ measured in advance as described above into spectral absorbance is used. The spectral absorbance g(λ) is represented by the following equation (1) below when the strength of the incoming light for each wavelength λ is I₀(λ), and the strength of the outgoing light (i.e. the measurement value) for each wavelength λ is I(λ). As the strength of the incoming light I₀(λ), for example, the strength of the outgoing light I(λ) at the background of the specimen from which the measurement value is obtained (i.e., the pixel values for each band in the background of the multiband image obtained from the specimen) is used.

$$g ( λ ) = - log \frac{I ( λ )}{{I}_{0} ( λ )} \qquad ( 1 )$$

In the first embodiment, for example, a principal component analysis is performed on the spectral absorbances of the N measurement values in the absorbance space: g₁(λ), g₂(λ), . . . , g_{N}(λ), and regression equations for obtaining a first principal component to a pth principal component are calculated. Here, p is the number of the bands, and p is “6” in the example of the first embodiment.

Next, the number of components k by which a cumulative contribution ratio becomes a predetermined value (for example, “0.8”) or more is determined. In the principal component analysis, a main characteristic characterizing the structure is determined by a first principal component to a kth principal component (hereinafter these are collectively and simply referred to as “principal component”). Meanwhile, the (k+1)-th principal component to the p-th principal component (hereinafter these are collectively and simply referred to as “residual component”) have a low contribution ratio when determining a characteristic of the structure.

A statistic of the residual components obtained for each measurement value as described above are calculated. For example, the sum of squares of the residual components (the (k+1)-th principal component to the p-th principal component) is calculated as the statistic. The sum of squares may be obtained after weighting each of the residual components from the (k+1)-th principal component to the p-th principal component by using predetermined weights. The statistic is not limited to the sum of squares, and different statistics may be used.

Data of each of the regression equations for obtaining the principal components (the first principal component to p-th principal component), the number of components k for determining the principal components, the residual components for each of the N measurement values (hereinafter referred to as “base residual component”), and the statistic of the base residual components for each measurement values (the statistic is the sum of squares; hereinafter referred to as “base residual component statistic”) is obtained as characteristic information related to the structure to be defined.

The above processing is performed on each of the structures, the characteristic information of all the structures that can be selected as the extraction target structure is defined, and the characteristic information is recorded in the recording unit 47 as the structure characteristic information 475.

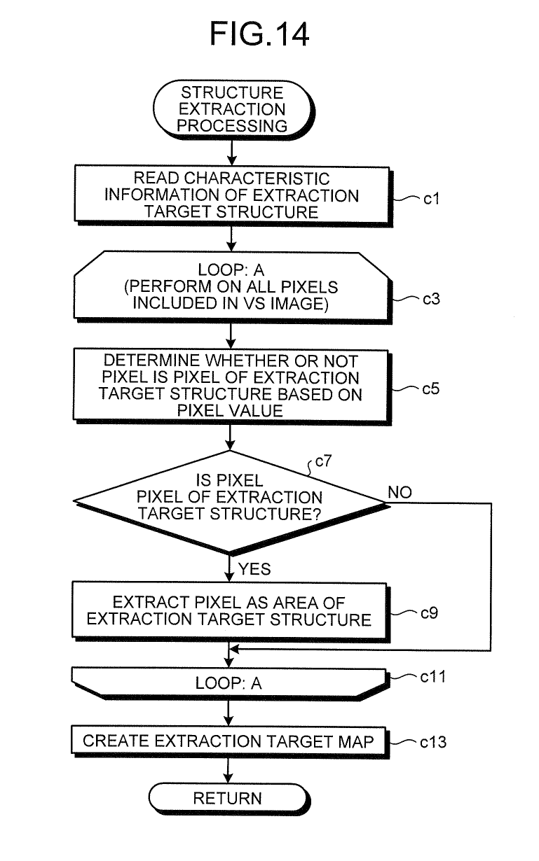

In the structure extraction process performed in step b7 in FIG. 12, while sequentially targeting each pixel of the VS image, the structure extraction unit 455 sequentially determines whether or not each pixel is the extraction target structure on the basis of the characteristic information of the set extraction target structure in the structure characteristic information 475. FIG. 14 is a flowchart showing a detailed processing procedure of the structure extraction process according to the first embodiment.

As shown in FIG. 14, in the structure extraction process, first, the structure extraction unit 455 reads the characteristic information of the specified extraction target structure from the structure characteristic information 475 (step c1). Then, while sequentially targeting each pixel included in the VS image, the structure extraction unit 455 performs processing of loop A on all the pixels included in the VS image (step c3 to step c11).

Specifically, first, the structure extraction unit 455 determines whether or not the processing target pixel is the extraction target structure (step c5). In a specific processing procedure, first, the structure extraction unit 455 converts pixel values for each wavelength λ (for each band) of the processing target pixel into spectral absorbances by using equation (1) described above. At this time, as the strength of the incoming light I₀(λ), the spectral data in the background of the target specimen S which is recorded as the background spectral information 515 (refer to FIG. 10) in the VS image file 5 is used. Next, the residual components are obtained by applying the regression equations for obtaining the principal components to the processing target pixel on the basis of the characteristic information of the extraction target structure read in step c1. Next, the sum of squares of the obtained residual components is calculated. Then, the calculated value is compared with the base residual component statistic, and processed by threshold processing. When the calculated value is within a predetermined range (for example, within two times the standard deviation), the processing target pixel is determined to be the extraction target structure. When the calculated value is not within the predetermined range, the processing target pixel is determined not to be the extraction target structure. In the threshold processing performed here, the threshold value used as the criterion to determine whether or not the processing target pixel is the extraction target structure may be a predetermined fixed value, or, for example, may be a value that can be changed according to a user operation.

When the structure extraction unit 455 determines that the processing target pixel is a pixel of the extraction target structure in the manner as described above (step c7: Yes), the structure extraction unit 455 extracts the processing target pixel as an area of the extraction target structure (step c9), and thereafter ends the processing of loop A for the processing target pixel. When the structure extraction unit 455 determines that the processing target pixel is not a pixel of the extraction target structure (step c7: No), the structure extraction unit 455 ends the processing of loop A for the processing target pixel without doing anything.

When the structure extraction unit 455 has performed the processing of loop A on all the pixels included in the VS image as processing targets, the structure extraction unit 455 creates an extraction target map in which whether each pixel is the extraction target structure or not is set (step c13). Data of the extraction target map is recorded in the recording unit 47. Thereafter, the process returns to step b7 in FIG. 12, and moves to step b9. When a plurality of extraction target structures are specified, the structure extraction process described above is performed for each of extraction target structures, and the extraction target map is created for each of the extraction target structures.

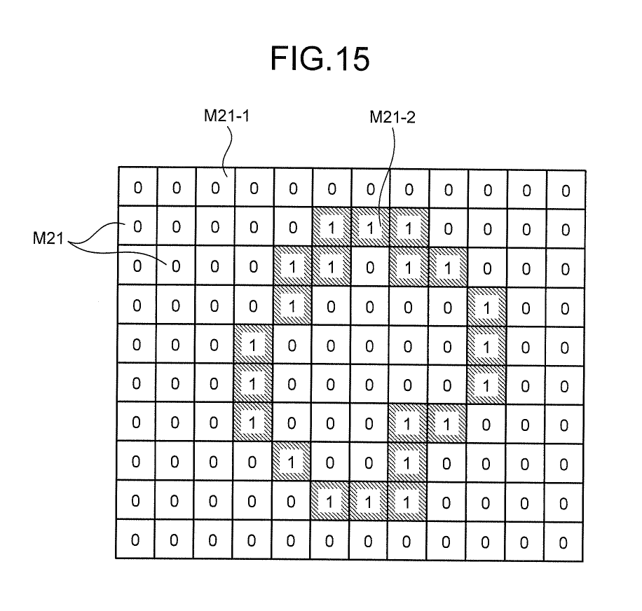

FIG. 15 is a diagram showing a data configuration example of the extraction target map. In FIG. 15, blocks M21 respectively correspond to pixel positions of the pixels included in the VS image, and determination results showing whether or not each pixel of the VS image is the extraction target structure are set in the extraction target map for all the pixels in the VS image. In FIG. 15, for the sake of simplicity, the extraction target map in which determination results of 10×12 pixels are set is illustrated. For example, as shown in the block M21-1, “0” is set to a block corresponding to a pixel that is determined not to be the extraction target structure. On the other hand, as shown in the block M21-2, “1” is set to a block corresponding to a pixel that is determined to be the extraction target structure.

Although, here, all the pixels included in the VS image are determined whether or not to be the extraction target structure, only pixels in a predetermined area of the VS image may be determined whether or not to be the extraction target structure for shortening the processing time. For example, the pixels in the specimen area determined in step all in FIG. 6 may be determined whether or not to be the extraction target structure. Or, before extracting the extraction target structure, an RGB image to be displayed may be synthesized from the VS image and displayed, and an area selection by a user may be received. For example, the pixels in the area selected by the user using a mouse included in the input unit 41 may be determined whether or not to be the extraction target structure.

Thereafter, as shown in FIG. 12, the display image generator 456 performs display change process of the area of the extraction target structure extracted in step b7 in accordance with a specified display method, and generates a display image in which the extraction target structure in the target specimen S appearing in the VS image is represented by the specified display method (step b9). The first embodiment is an embodiment in which the “highlight” is specified as the display method of the extraction target structure, and the display image generator 456 first synthesizes an RGB image from the VS image on the basis of spectral sensitivity characteristics of each band of R, G, and B.

Next, the display image generator 456 refers to the extraction target map created in step c13 in FIG. 14, and generates a display image in which the area of the extraction target structure in the synthesized RGB image is represented by a specified display color. Specifically, the display image generator 456 generates the display image by replacing the pixel values of the pixel positions for which “1” is set in the extraction target map by the specified display color. At this time, if a plurality of extraction target structures is specified and a plurality of extraction target maps are created, the display image generator 456 refers to each extraction target map, and replaces pixel values in the areas of the specified extraction target structures by the display color specified for each extraction target structure respectively. The display image generator 456 may replace pixel values in the areas of each extraction target structure by the display color of the extraction target structure respectively and individually in the synthesized RGB image, and may generate a display image for each specified extraction target structure. It is possible to switch the above described display methods as necessary according to a user operation, and perform the display process.

As shown in FIG. 12, the VS image display processing unit 454 performs process for displaying the display image generated in step b9 on the display unit 43 (step b11).

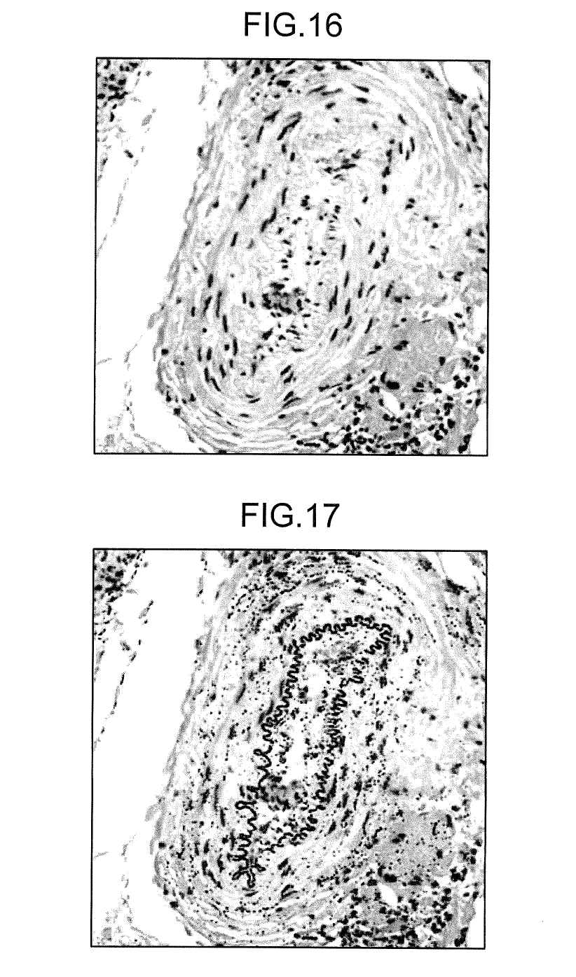

FIG. 16 is a diagram showing an example of the VS image, and shows the VS image which is acquired from a specimen, which is used as the target specimen S, including an elastic fiber on which the HE staining is performed as the standard staining. On the other hand, FIG. 17 is a diagram showing an example of a display image of the VS image in FIG. 16, and shows a display image generated when a user specifies the extraction target structure to be “elastic fiber” and the display method to be “highlighted display”. As shown in FIG. 16, it is difficult to visually check an area of the elastic fiber in the VS image before the display change process. On the other hand, as shown FIG. 17, it is possible to easily distinguish the area of the elastic fiber from other areas in the display image generated by performing the display change process on the VS image in FIG. 16 and highlighting the area of the elastic fiber.

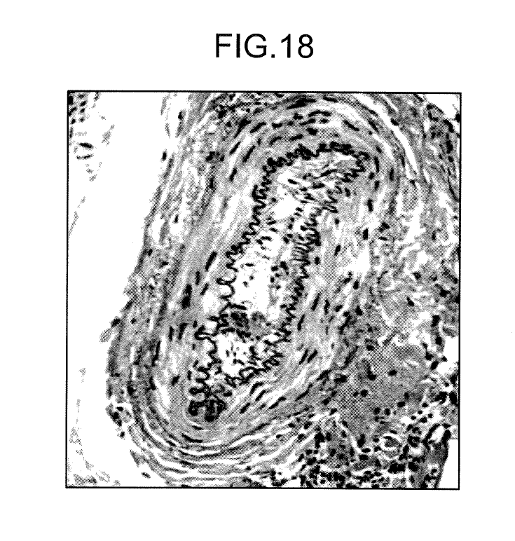

FIG. 18 is a diagram showing an image example of a specimen generated by further performing a special staining on a specimen similar to the target specimen S which is the subject of the VS image illustrated in FIG. 16 (for example, the specimen is another segment of a specimen block which is the same as the target specimen S, and the specimen includes an elastic fiber on which the HE staining is performed as the standard staining), and visualizing the elastic fiber. As shown in FIG. 18, when the special staining is performed on the specimen, areas of the elastic fiber in the specimen are differently stained, so that the areas can be visually distinguished.

As described above, according to the first embodiment, it is possible to highlight the area of the extraction target structure by image processing without actually performing a special staining as shown in FIG. 18 on the specimen. Therefore, it is possible to present an image showing a desired structure in the target specimen S with good visibility to a user, so that diagnostic accuracy can be improved. Also, since a special staining need not be performed, the production cost of the specimen can be reduced, and the diagnostic time can be shortened. By specifying one structure or a combination of a plurality of structures desired to be observed as the extraction target structure, and specifying the highlighted display as the display method, a user can easily distinguish the area of the extraction target structure in the target specimen S from other areas, and can observe the extraction target structure in the target specimen S with good visibility.

In the first embodiment, the residual component is obtained for each pixel in the VS image on the basis of the characteristic information defined for the extraction target structure in advance, and a pixel whose statistic of the residual component is within a predetermined range of the base residual component statistic is extracted as the extraction target structure. On the other hand, in a second embodiment, a display characteristic value (for example, saturation, brightness, and the like) is corrected when displaying the extraction target structure by the specified color on the basis of a difference between the statistic of the residual component and the base residual component statistic (hereinafter referred to as “residual difference value”). Here, the residual difference value corresponds to an accuracy of structure extraction (structure extraction accuracy) of each pixel included in the VS image.

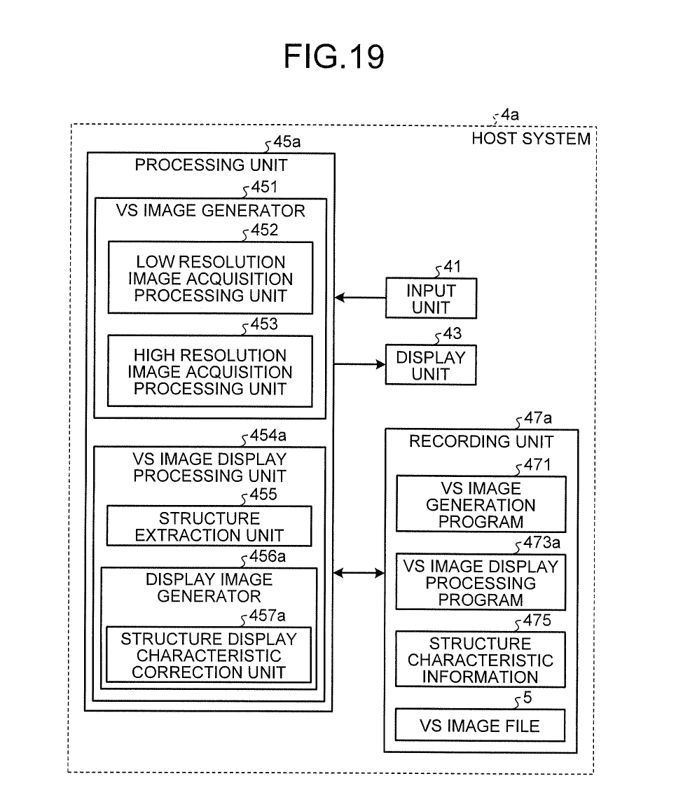

FIG. 19 is a diagram showing main functional blocks of a host system 4a according to the second embodiment. The same reference numerals are given to the same components as those described in the first embodiment. As shown in FIG. 19, the host system 4a included in a microscope system according to the second embodiment includes the input unit 41, the display unit 43, a processing unit 45a, a recording unit 47a, and the like.

A VS image display processing unit 454a in the processing unit 45a includes the structure extraction unit 455 and a display image generator 456a that includes a structure display characteristic correction unit 457a. The structure display characteristic correction unit 457a performs process for correcting a display characteristic of each pixel which is determined to be the extraction target structure by the structure extraction unit 455. In the recording unit 47a, a VS image display processing program 473a for causing the processing unit 45a to function as the VS image display processing unit 454a and the like are recorded.

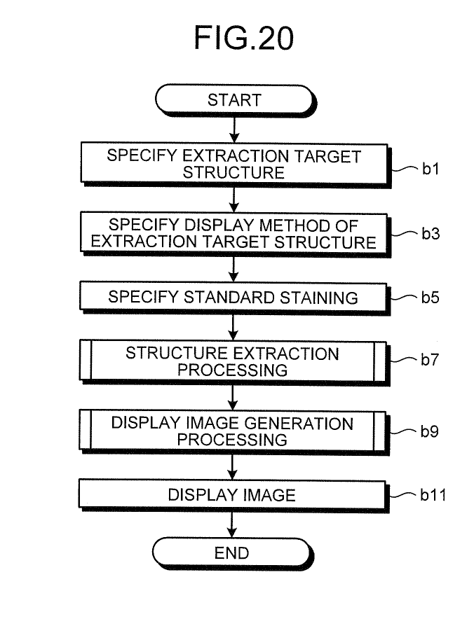

FIG. 20 is a flowchart showing a processing procedure of VS image display process according to the second embodiment. The processing described here is realized by the VS image display processing unit 454a reading and executing the VS image display processing program 473a recorded in the recording unit 47a, and in FIG. 20, the same processes as those in the first embodiment are given the same reference numerals.

In the second embodiment, as shown in FIG. 20, the structure extraction unit 455 performs the structure extraction process after the type of the standard staining is specified in step b5 (step b7). In the structure extraction process, whether or not the processing target pixel is the extraction target structure is calculated by obtaining the residual component of the processing target pixel in the same way as in the first embodiment and comparing the statistic (sum of squares) of the obtained residual component with the base residual component statistic to perform threshold processing. However, in the second embodiment, the structure extraction unit 455 obtains the residual difference value, which is a difference between the statistic of the residual component and the base residual component statistic, for the processing target pixel determined to be the extraction target structure, and records the residual difference value in the recording unit 47a.

Next, the display image generator 456a performs display image generation process (step d9). Thereafter, in the same way as in the first embodiment, the VS image display processing unit 454a performs process for displaying the display image generated in step d9 on the display unit 43 (step b11).

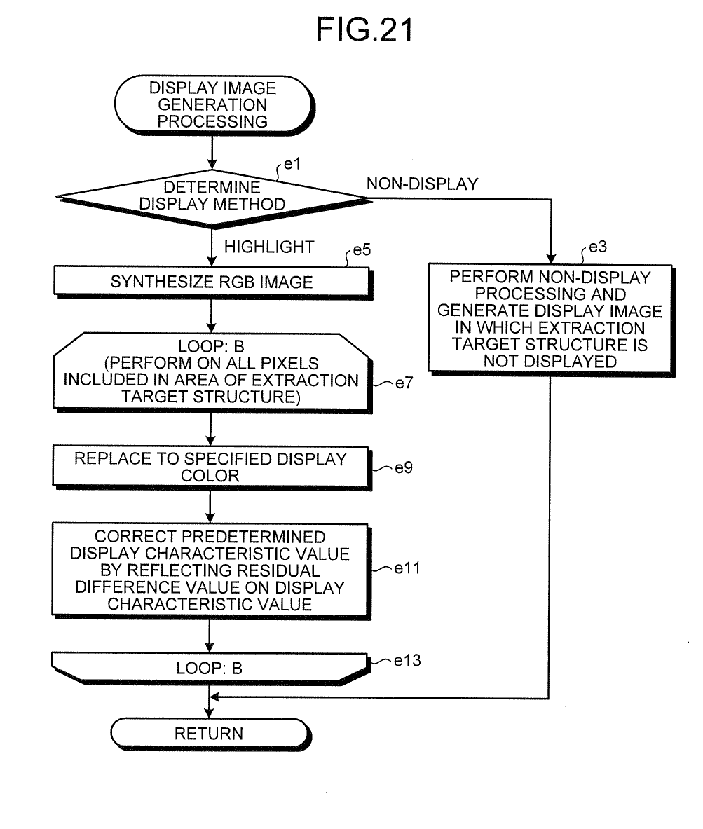

Here, the display image generation process in step d9 will described. In the display image generation process, in the same manner as in the first embodiment, the display change process of the area covering the extraction target structure is performed in accordance with the specified display method, and a display image in which the extraction target structure in the target specimen S appearing in the VS image is represented by the specified display method is generated. At this time, the display characteristic value of each pixel determined to be the extraction target structure is corrected on the basis of the residual difference value obtained in the structure extraction process. FIG. 21 is a flowchart showing a detailed processing procedure of the display image generation process according to the second embodiment.

As shown in FIG. 21, in the display image generation process, the display image generator 456a, first, branches the process according to the specified display method (step e1). If the display method is “non-display”, the process moves to step e3, and the display image generator 456a performs non-display process described below in a fourth embodiment, and generates a display image in which the extraction target structure is not displayed (step e3). Thereafter, the process returns to step d9 in FIG. 20.

In the second embodiment, a case in which the “highlight” is specified as the display method of the extraction target structure is considered, and the process moves to step e5 when the display method is “highlight”. Then, the display image generator 456a, first, synthesizes an RGB image from the VS image by using spectral sensitivities of each of R, G, and B bands (step e5). Next, while sequentially targeting each pixel extracted as the extraction target structure in step b7 in FIG. 20, the display image generator 456a performs processing of loop B on all the extracted pixels (step e7 to step e13).

In the loop B, first, the display image generator 456a replaces the pixel value of the processing target pixel by the specified display color (step e9). Next, the display image generator 456a corrects a predetermined display characteristic value of the processing target pixel by reflecting the residual difference value obtained for the processing target pixel on the display characteristic value (step ell).

For example, a look-up table (hereinafter abbreviated as “LUT”) in which a relationship between the residual difference value and a predetermined display characteristic value on which the residual difference value is reflected is defined is created in advance, and recorded in the recording unit 47a, and the display characteristic value of the processing target pixel is corrected by referring to the LUT. The display characteristic value on which the residual difference value is reflected includes, for example, saturation, brightness, and the like.

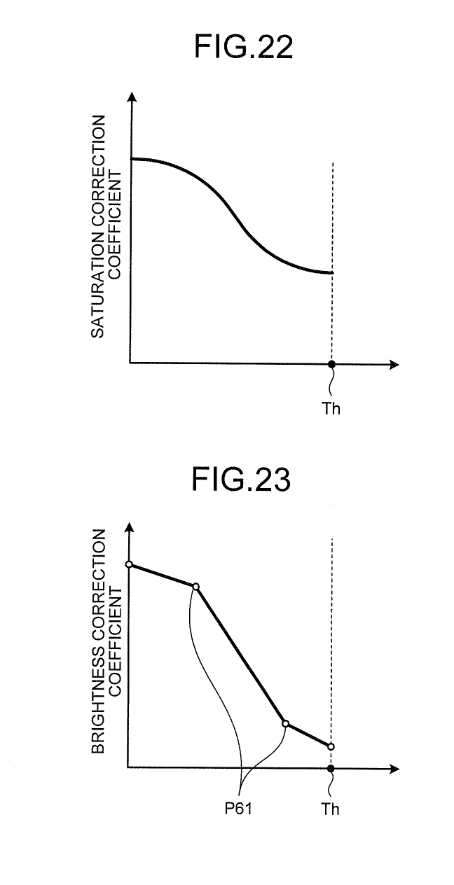

FIG. 22 is a diagram showing an example of the LUT when correcting saturation that is an example of the display characteristic value, and schematically showing the LUT with the horizontal axis being inputted residual difference value and the vertical axis being outputted saturation correction coefficient. FIG. 23 is a diagram showing an example of the LUT when correcting brightness that is another example of the display characteristic value, and schematically showing the LUT with the horizontal axis being inputted residual difference value and the vertical axis being outputted brightness correction coefficient. In FIGS. 22 and 23, a threshold value Th, by which the processing target pixel is determined as the extraction target structure, is indicated by a dashed line.

When applying the LUT of FIG. 22, the saturation correction coefficient is determined so that the smaller the residual difference value is, the higher the saturation of the pixel to be displayed is. In this case, the display image generator 456a calculates the saturation of the processing target pixel, and corrects the saturation by multiplying the calculated value by the saturation correction coefficient. Specifically, by using a publicly known technique, an RGB value of the processing target pixel is converted into an HSV value. The value of obtained saturation S is then corrected by multiplying the value of obtained saturation S by the saturation correction coefficient determined by the LUT, and thereafter, the HSV value is reconverted into the RGB value, so that the residual difference value is reflected on the display characteristic value. As a result, the smaller the residual difference value is, the higher the saturation of the pixel determined to be the extraction target structure is, and the pixel is displayed with more vivid color.

When applying the LUT of FIG. 23, the brightness correction coefficient is determined so that the smaller the residual difference value is, the higher the brightness of the pixel to be displayed is. In this case, the display image generator 456a obtains the value of brightness V from the RGB value of the processing target pixel by using a publicly known technique. Then, the display image generator 456a corrects the value of brightness V by multiplying the value of brightness V by the brightness correction coefficient determined by the LUT, and reconverting the HSV value into the RGB value, so that the display image generator 456a reflects the residual difference value on the display characteristic value. As a result, the smaller the residual difference value is, the higher the brightness of the pixel determined to be the extraction target structure is, and the pixel is displayed with brighter color.

The LUT shown in FIG. 22 shows an LUT defined as a fixed function in advance. On the other hand, the LUT shown in FIG. 23 shows an LUT defined as a two-dimensional data table in which a relationship between input values and output values corresponding to plots P61 is set. In the LUT of FIG. 23, output values are obtained as values on a line segment linearly connecting between the plots P61 (brightness correction coefficients are obtained in the example of FIG. 23). It is not necessary to connect the plots P61 with a straight line, but it is possible to obtain a function equation of an approximate curve on the basis of the plots P61 and obtain output values between the plots P61. It is also possible to display the graph of FIG. 23 on the display unit 43 and present the graph to a user, and data content in the LUT can be adjusted in accordance with a user operation. For example, when the user moves a desired plot P61 by the mouse included in the input unit 41, the data content in the LUT may be changed in accordance with the position of the plot P61 having been moved.

When the predetermined display characteristic value of the processing target pixel has been corrected in the manner described above, the display image generator 456a ends the processing of loop B for the processing target pixel. When the display image generator 456a completes the processing of loop B for all the processing target pixels that are all the pixels included in the area of the extraction target structure, the process returns to step d9 in FIG. 20.

Even a pixel, which is determined to be the extraction target structure as a result of the threshold processing in which the structure extraction unit 455 performs threshold processing on the obtained statistic of the residual component, has different accuracies (structure extraction accuracies) whether or not the pixel is actually the extraction target structure depending on the residual component. Specifically, the smaller the residual component is, the higher the possibility to be the extraction target structure is, and the larger the residual component is, the lower the possibility to be the extraction target structure is.

According to the second embodiment, it is possible to calculate a residual difference value (a difference between the statistic of the residual component obtained for each pixel of the VS image by the structure extraction unit 455 and the base residual component statistic) for each pixel determined to be the extraction target structure. When highlighting the pixel values of the pixels of the extraction target structure by replacing the pixel values by the specified display color, it is possible to correct the pixels while the residual difference values of the pixels are reflected on the predetermined display characteristic value of each pixel. For example, it is possible to display that the smaller the residual difference value is and the higher the possibility to be the extraction target structure is, the higher the saturation and brightness of the pixel are, but the larger the residual difference value is and the lower the possibility to be the extraction target structure is, the lower the saturation and brightness of the pixel are.

Therefore, the same effects as those of the first embodiment can be produced, and the structure extraction accuracy whether or not the pixel is the extraction target structure can be visually presented for each pixel. A user can easily grasp the structure extraction accuracy whether or not the pixels are the extraction target structure by the display characteristic values (for example, the degree of brightness, the degree of color vividness, and the like) of the pixels which are extracted as the extraction target structure and highlighted with the specified display color. The user can perform observation while grasping the structure extraction accuracy whether or not the pixels are the extraction target structure. Based on this, the diagnostic accuracy can be further improved.

Although, in the second embodiment, a case is described in which saturation or brightness is corrected on the basis of the residual difference value of each pixel which is determined to be the extraction target structure, the display characteristic value on which the residual difference value is reflected is not limited to saturation and brightness. The display characteristic value on which the residual difference value is reflected needs not necessarily be one, but the residual difference value may be reflected on a plurality of display characteristic values. For example, the residual difference value may be reflected on both the saturation and the brightness to correct the saturation and the brightness.

In the first embodiment or the like, the residual component is obtained for each pixel in the VS image on the basis of the characteristic information defined for the extraction target structure in advance, and a pixel whose statistic of the residual component is within a predetermined range of the base residual component statistic is extracted as the extraction target structure. However, a characteristic of the structure may vary depending on individual difference between specimens to be observed or diagnosed. For example, the characteristic of the structure varies depending on the fixing condition for fixing the tissue in the specimen and the staining condition for staining the specimen (time required for staining, concentration of staining fluid, and the like). Therefore, a case may occur in which pixels of an area that is not the extraction target structure are erroneously extracted, and conversely, a case may occur in which pixels that are the extraction target structure are not extracted and the like. A third embodiment is to modify the extraction result of the extraction target structure in accordance with a user operation.

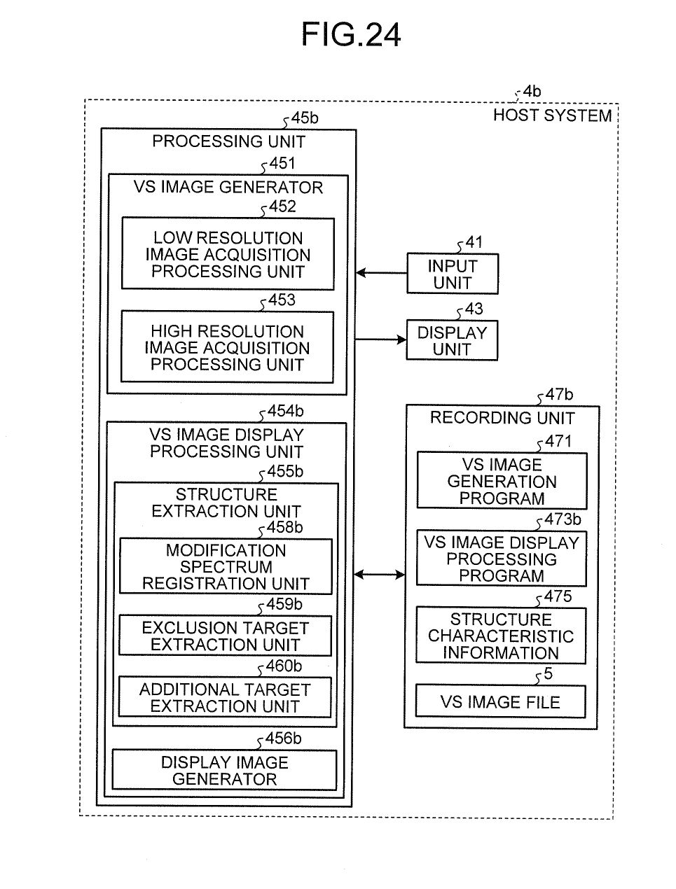

FIG. 24 is a diagram showing main functional blocks of a host system 4b according to the third embodiment. The same reference numerals are given to the same components as those described in the first embodiment. As shown in FIG. 24, the host system 4b included in a microscope system according to the third embodiment includes the input unit 41, the display unit 43, a processing unit 45b, a recording unit 47b, and the like.

A VS image display processing unit 454b of the processing unit 45b includes a structure extraction unit 455b including a modification spectrum registration unit 458b as an exclusion target specifying unit, an exclusion spectrum setting unit, an additional target specifying unit, and an additional spectrum setting unit, an exclusion target extraction unit 459b as an exclusion target extraction unit, and an additional target extraction unit 460b, and a display image generator 456b. The modification spectrum registration unit 458b performs process for registering exclusion spectrum information in accordance with a user operation, or registering additional spectrum information in accordance with a user operation. The exclusion target extraction unit 459b performs process for extracting a pixel to be excluded from the area of the extraction target structure on the basis of the exclusion spectrum information. The additional target extraction unit 460b performs process for extracting a pixel to be added to the area of the extraction target structure on the basis of the additional spectrum information. In the recording unit 47b, a VS image display processing program 473b for causing the processing unit 45b to function as the VS image display processing unit 454b and the like are recorded.

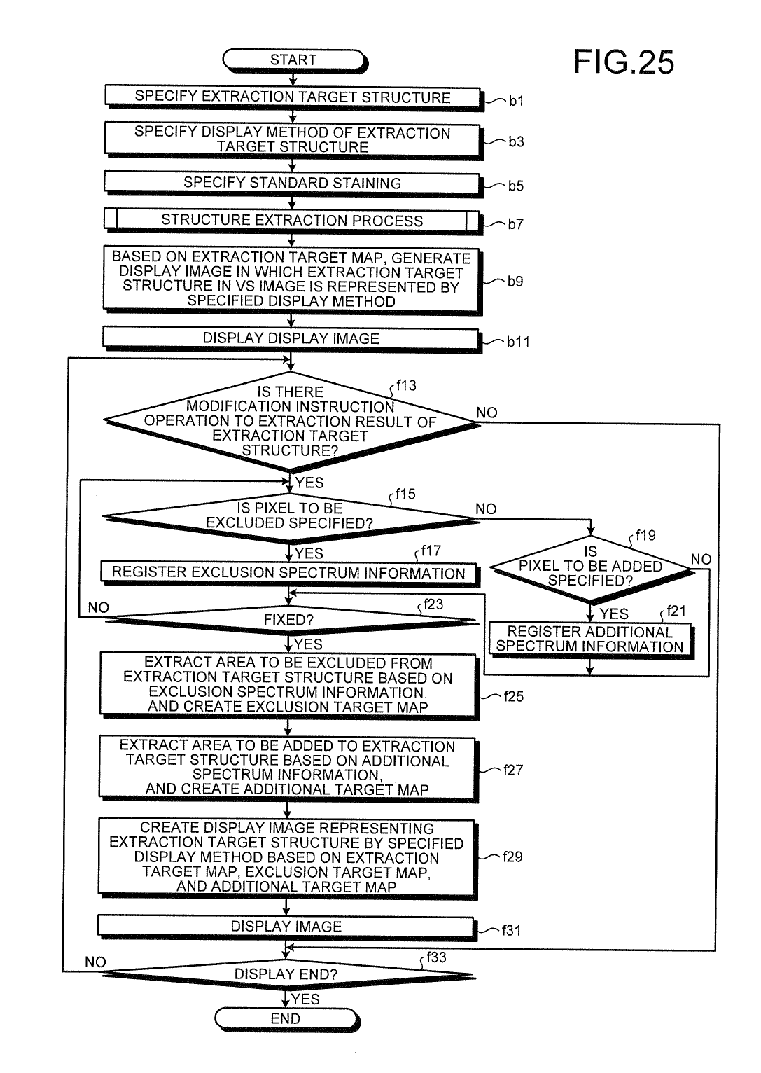

FIG. 25 is a flowchart showing a processing procedure of VS image display process according to the third embodiment. The processing described here is realized by the VS image display processing unit 454b reading and executing the VS image display processing program 473b recorded in the recording unit 47b, and in FIG. 25, the same processes as those in the first embodiment are given the same reference numerals.

In the third embodiment, as shown in FIG. 25, the display image generator 456b displays the display image on the display unit 43 in step b11, and thereafter, the modification spectrum registration unit 458b receives a modification instruction operation with respect to the result of extraction of the extraction target structure performed in step b7. If the modification instruction operation is not inputted (step f13: No), the process moves to step f33.

If the modification instruction operation is inputted via the input unit 41 (step f13: Yes), the modification spectrum registration unit 458b then specifies a pixel to be excluded or a pixel to be added in accordance with a user operation. For example, the modification spectrum registration unit 458b specifies a pixel to be excluded by receiving a selection operation of the pixel position of the pixel to be excluded on the display screen displayed in step b11. Or, the modification spectrum registration unit 458b specifies a pixel to be added by receiving a selection operation of the pixel position of the pixel to be added on the display screen.

When the pixel to be excluded is specified (step f15: Yes), the modification spectrum registration unit 458b reads pixel values for each band (each wavelength λ) of the specified pixel from the image data 58 (refer to FIG. 11) in the VS image file 5, and registers the pixel values as the exclusion spectrum information (step f17). When a plurality of pixels to be excluded is specified, the pixel values of the pixels are respectively registered as the exclusion spectrum information. On the other hand, when the pixel to be added is specified (step f19: Yes), the modification spectrum registration unit 458b reads pixel values for each band of the specified pixel from the image data 58 in the VS image file 5, and registers the pixel values as the additional spectrum information (step f17).

Thereafter, until the operation is fixed (step f23: No), the process returns to step f15. When the operation is fixed (step f23: Yes), first, the exclusion target extraction unit 459b extracts the pixel to be excluded from the area of the extraction target structure on the basis of the exclusion spectrum information registered in step f17, and creates an exclusion target map (step f25). Specifically, first, the exclusion target extraction unit 459b refers to the extraction target map created in the structure extraction process in step b7, and reads pixels extracted as the area of the extraction target structure. While sequentially targeting each of the read pixels, the exclusion target extraction unit 459b sequentially determines whether or not each pixel is excluded from the extraction target structure on the basis of the exclusion spectrum information.

For example, the exclusion target extraction unit 459b compares the pixel values for each band (for each wavelength λ) of the processing target pixel and the exclusion spectrum information, obtains differences between the pixel values and the exclusion spectrum information for each wavelength λ, and calculates the sum of squares of the obtained differences. The exclusion target extraction unit 459b performs threshold processing on the calculated value by using a predetermined threshold value set in advance, and for example, extracts the processing target pixel by determining that the processing target pixel is excluded from the area of the extraction target structure when the calculated value is smaller than the threshold value. Here, when a plurality of exclusion spectrum information items are registered, it is possible to select one of the exclusion spectrum information items as a representative value and determine that the processing target pixel is excluded when the sum of squares of differences between the pixel values and the representative value is smaller than the threshold value, and also it is possible to determine that the processing target pixel is excluded when the sum of squares of differences between the pixel values and all of the exclusion spectrum information items is smaller than the threshold value on the basis of the exclusion spectrum information items. The threshold value used in the threshold processing may be a predetermined fixed value, or, for example, may be a value that can be changed according to a user operation.

The exclusion target extraction unit 459b creates an exclusion target map in which the determination result indicating whether or not pixels are excluded from the area of the extraction target structure is set. In the processing here, an additional target map is created in which, in the pixel positions at which “1” is set in the extraction target map, the values at the pixel positions which are determined to be excluded from the area of the extraction target structure in the above processing are changed to “0”.

Next, the additional target extraction unit 460b extracts the pixel to be added as the area of the extraction target structure on the basis of the additional spectrum information registered in step f21, and creates an additional target map (step f27). Specifically, first, the additional target extraction unit 460b refers to the extraction target map, and reads pixels not extracted as the area of the extraction target structure. While sequentially targeting each of the read pixels, the additional target extraction unit 460b sequentially determines whether or not each pixel is added to the extraction target structure on the basis of the additional spectrum information.

For example, in the same way as the exclusion target extraction unit 459b, the additional target extraction unit 460b compares the pixel values for each band (for each wavelength λ) of the processing target pixel and the additional spectrum information, obtains differences between the pixel values and the additional spectrum information for each wavelength λ, and calculates the sum of squares of the obtained differences. The additional target extraction unit 460b performs threshold processing on the calculated value by using a predetermined threshold value set in advance, and for example, extracts the processing target pixel by determining that the processing target pixel is added as the area of the extraction target structure when the calculated value is smaller than the threshold value.

The additional target extraction unit 460b creates an additional target map in which the determination result indicating whether or not pixels are added as the area of the extraction target structure is set. In the processing here, the additional target map is created in which the values at the pixel positions which are determined to be added to the area of the extraction target structure in the above processing are changed to “1”.

Here, pixel values for each band of the pixel to be excluded which is specified in accordance with a user operation are used as the exclusion spectrum information, and the extraction result of the extraction target structure is modified by using the exclusion spectrum information. Also, pixel values for each band of the pixel to be added which is specified in accordance with a user operation are used as the additional spectrum information, and the extraction result of the extraction target structure is modified by using the additional spectrum information. On the other hand, the pixel to be excluded or the pixel to be added may be once converted into spectral absorbance, and the extraction result of the extraction target structure may be modified by performing threshold processing on the spectral absorbance in the absorbance space.

In this case, for example, the modification spectrum registration unit 458b converts pixel values for each band of a pixel specified as the pixel to be excluded or the pixel to be added into spectral absorbances on the basis of the background spectral information 515 (refer to FIG. 10) by using equation (1) described above, and registers the spectral absorbances as the exclusion spectrum information. While sequentially targeting each of the pixels extracted as the area of the extraction target structure, the exclusion target extraction unit 459b sequentially determines whether or not each pixel is excluded from the extraction target structure on the basis of the exclusion spectrum information. Specifically, the exclusion target extraction unit 459b converts pixel values for each band (for each wavelength λ) of the processing target pixel into spectral absorbances on the basis of the background spectral information 515 by using equation (1) described above. Next, the exclusion target extraction unit 459b compares the obtained spectral absorbances of the processing target pixel and the exclusion spectrum information, obtains differences between the spectral absorbances and the exclusion spectrum information for each wavelength λ, and calculates the sum of squares of the obtained differences. The exclusion target extraction unit 459b then performs threshold processing on the calculated value by using a predetermined threshold value set in advance, and for example, determines that the processing target pixel is excluded from the area of the extraction target structure when the calculated value is smaller than the threshold value. On the other hand, while sequentially targeting each of the pixels not extracted as the area of the extraction target structure, the additional target extraction unit 460b sequentially determines whether or not each pixel is added as the area of extraction target structure on the basis of the additional spectrum information. Specifically, the additional target extraction unit 460b converts pixel values for each band of the processing target pixel into spectral absorbances on the basis of the background spectral information 515 by using equation (1) described above. The additional target extraction unit 460b compares the obtained spectral absorbances of the processing target pixel and the additional spectrum information, obtains differences between the spectral absorbances and the exclusion spectrum information for each wavelength λ, and calculates the sum of squares of the obtained differences. The additional target extraction unit 460b then performs threshold processing on the calculated value by using a predetermined threshold value, and for example set in advance, determines that the processing target pixel is added as the area of the extraction target structure when the calculated value is smaller than the threshold value.

When the additional target map is created in the manner described above, next, the display image generator 456b modifies the extraction result of the extraction target structure on the basis of the extraction target map, the exclusion target map created in step f25, and the additional target map created in step f27, and generates a display image representing the modified extraction target structure in the target specimen S by the specified display method (step f29).

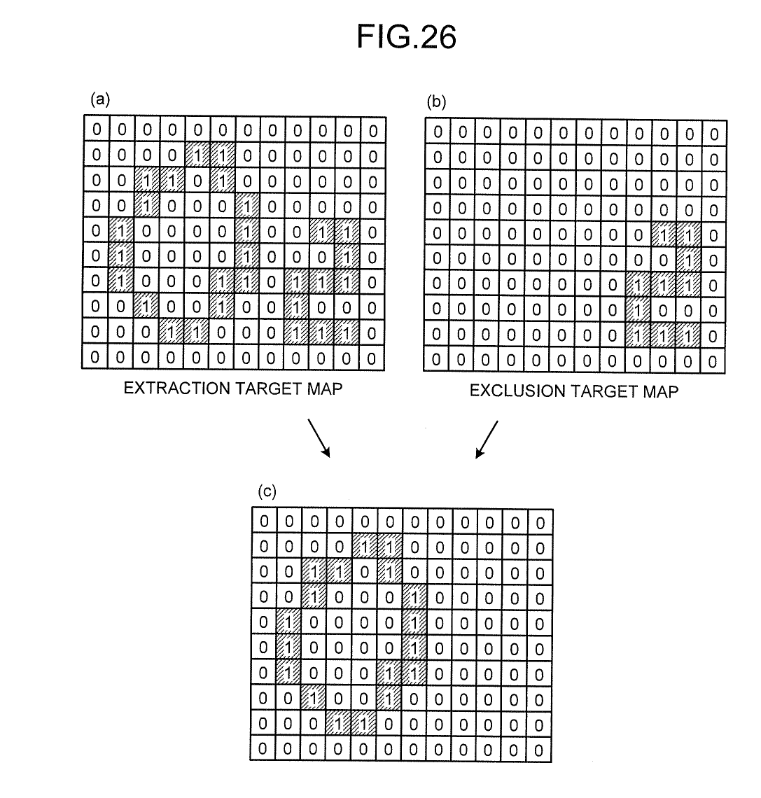

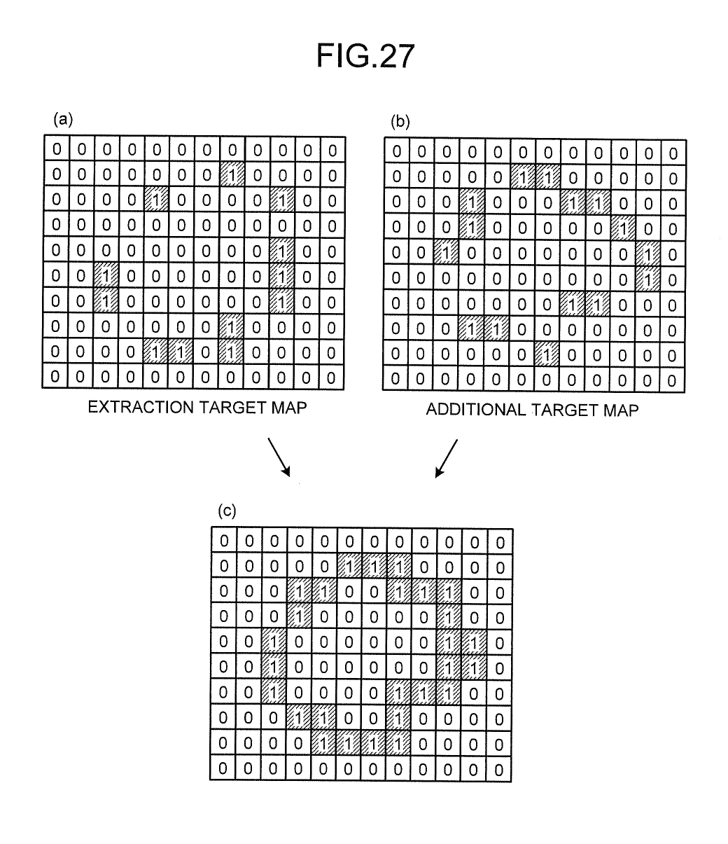

FIGS. 26 and 27 are illustrations for explaining a modification principle of the extraction result of the extraction target structure. FIGS. 26 and 27 illustrate the extraction target map, the exclusion target map, and the additional target map in which determination results of 10×12 pixels are set for the sake of simplicity.

Here, (a) of FIG. 26 shows an example of the extraction target map, and (b) of FIG. 26 shows an exclusion target map created on the basis of the exclusion spectrum information registered in accordance with a user operation. When the exclusion spectrum information is registered in accordance with a user operation and the exclusion target map is created, a difference between the extraction target map of (a) of FIG. 26 and the exclusion target map of (b) of FIG. 26 is calculated. As shown in (c) of FIG. 26, among pixels of pixel positions at which “1” is set in the extraction target map, pixels of pixel positions at which “1” is not set in the exclusion target map are defined as pixels of the area of the extraction target structure, and the pixel values of the pixels are replaced by the specified display color to generate a display image.

(a) of FIG. 27 shows an example of the extraction target map, and (b) of FIG. 27 shows an additional target map created on the basis of the additional spectrum information registered in accordance with a user operation. When the additional spectrum information is registered in accordance with a user operation and the additional target map is created, a logical OR operation is performed between the extraction target map of (a) of FIG. 27 and the additional target map of (b) of FIG. 27. As shown in (c) of FIG. 27, pixels of pixel positions at which “1” is set in the extraction target map or the additional target map are defined as pixels of the area of the extraction target structure, and the pixel values of the pixels are replaced by the specified display color to generate a display image.

The VS image display processing unit 454b then performs process for displaying the generated display image on the display unit 43 (step f31). Thereafter, the process moves to step f33, and until the display of the display image ends (step f33: No), the process returns to step f13. The display ends when, for example, a display end operation is inputted (step f33, Yes), and the process ends.

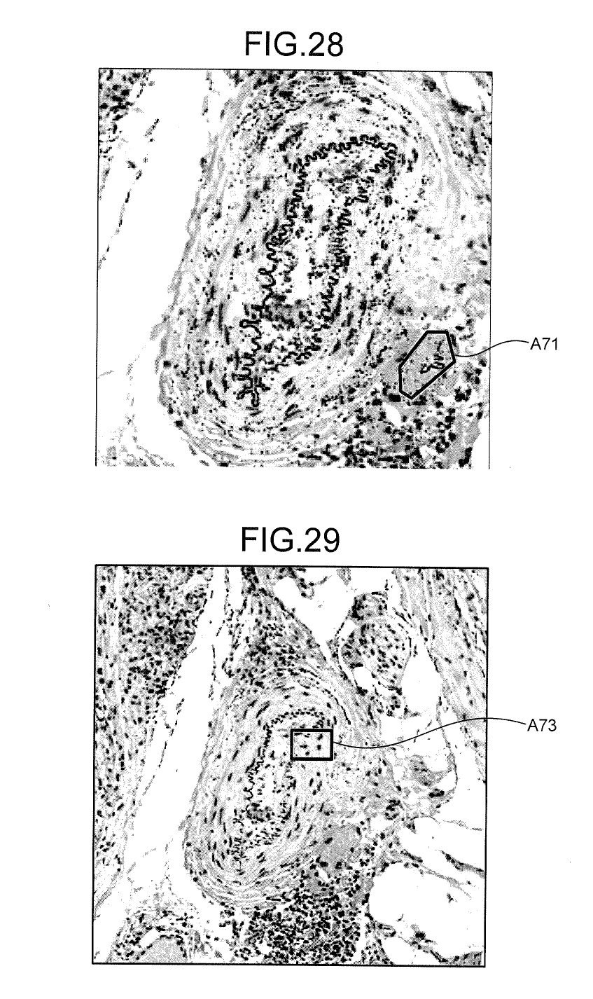

Next, an operation example when modifying the extraction result of the extraction target structure will be described. FIGS. 28 and 29 are diagrams showing an example of the display image displayed in step b11 in FIG. 25, and respectively shows a display image in which an area of elastic fiber is highlighted.

Here, the display image in FIG. 28 shows an example in which the area of elastic fiber which is the extraction target structure is excessively extracted. Specifically, an area of elastic fiber appearing in the center of the display image is highlighted, and also pixels in a lower right area A71 enclosed by a thick line in FIG. 28 are highlighted and extracted as an area of elastic fiber.

For example, when a user determines that the extraction result of the extraction target structure is obviously excessive in the display image, the user performs a selection operation of pixel positions to be excluded by using the mouse included in the input unit 41. The selection operation of pixel positions may be an operation to select the pixel positions desired to be excluded one by one, or may be an operation to select an area including the pixel positions desired to be excluded. Here, the operation to select an area will be described as an example. Specifically, first, the user selects an area (for example, the area A71 enclosed by a thick line in FIG. 28). While the area is selected, when right-clicking the mouse, a selection menu for selecting “Exclude” or “Add” is displayed, and the user selects the pixel positions to be excluded by selecting the “Exclude” from the selection menu. At this time, as internal process, process for specifying the pixels of the extraction target structure included in the area A71 enclosed by a thick line as an exclusion target is performed (step f15 in FIG. 25: Yes). Thereafter, the exclusion spectrum information is registered on the basis of the pixel values of the specified pixels.

On the other hand, the display image in FIG. 29 shows an example in which extraction omission occurs excessively in the area of the extraction target structure, and a part of an area of elastic fiber appearing in the center of the display image is highlighted in places. When the user determines that extraction omission of the extraction target structure obviously occurs in the display image, the user performs a selection operation of pixel positions to be added by using the mouse included in the input unit 41. The selection operation of pixel positions may be an operation to select the pixel positions desired to be added one by one, or may be an operation to select an area including the pixel positions desired to be added. Here, the operation to select an area will be described as an example. Specifically, first, the user selects an area (for example, an area A73 enclosed by a thick line in FIG. 29). While the area is selected, the user right-clicks the mouse, and selects the “Add” from the displayed selection menu.

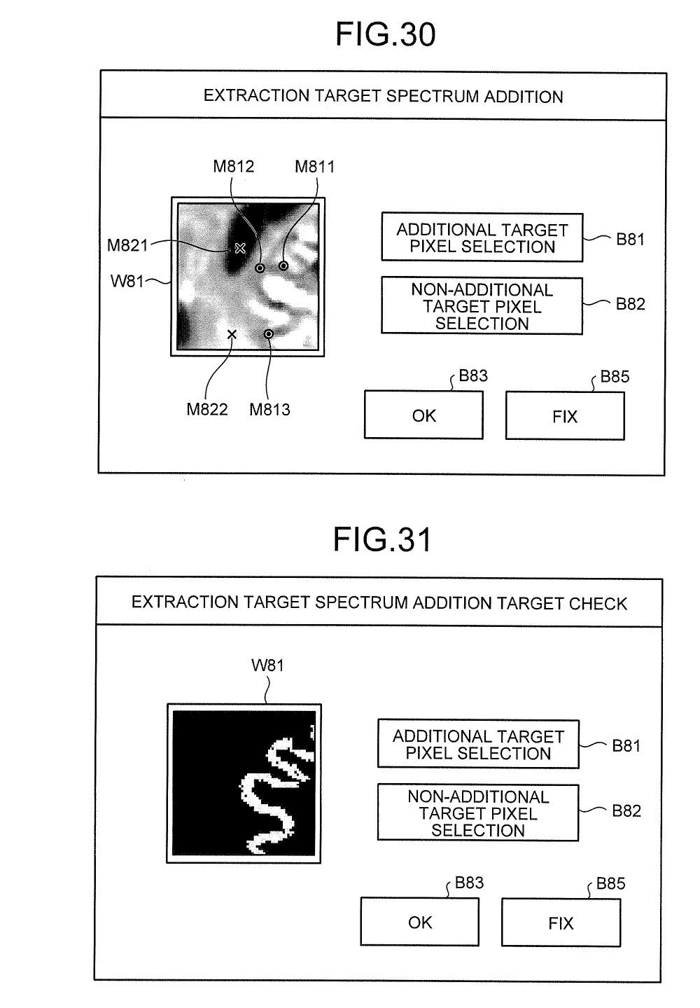

When the “Add” is selected from the selection menu, an extraction target spectrum addition screen is displayed. FIGS. 30 and 31 are diagrams showing an example of the extraction target spectrum addition screen. As shown in FIG. 30, the extraction target spectrum addition screen includes a selection area display unit W81, and an image (selected partial image) of the area (area A73 enclosed by a thick line in FIG. 29) selected in the display image in the manner described above is enlarged and displayed in the selection area display unit W81. At this time, process for intensifying contrast or the like may be performed on the selected partial image. In this way, the user can easily perform a selection operation of additional target pixel or non-additional target pixel described below in the selected partial image.

The extraction target spectrum addition screen includes an additional target pixel selection button B81 for selecting the additional target pixel on the selected partial image in the selection area display unit W81, a non-additional target pixel selection button B82 for selecting the non-additional target pixel on the selected partial image, an OK button B83 for fixing the selection operation of the additional target pixel and/or the non-additional target pixel, and a fix button 385 for fixing a selection operation of pixel position to be added.

In the extraction target spectrum addition screen, the user for example, clicks the additional target pixel selection button B81 by the mouse, and, while the selection of the additional target pixel is instructed, in the selection area display unit W81, the user clicks a pixel position desired to be the additional target pixel on the selected partial image by the mouse. A marker is placed on the clicked pixel position. The number of pixel positions to be selected may be one or more. In the example of FIG. 30, markers M811 to M813 are arranged on three pixel positions selected by the user as the additional target pixels. Or, the user clicks the non-additional target pixel selection button 382 by the mouse, and, while the selection of the non-additional target pixel is instructed, in the selection area display unit W81, the user clicks a pixel position desired not to be the additional target pixel on the selected partial image by the mouse. A marker having a shape different from the markers M811 to M813 indicating an additional target pixel is placed on the clicked pixel position. For example, in the example of FIG. 30, markers M821 and M822 are arranged on two pixel positions selected by the user as elimination target pixels. Thereafter, the OK button 383 is clicked.

As internal process at this time, for example, process for binarizing the selected partial image is performed. Specifically, pixel values similar to each other in the selected partial image are extracted on the basis of the pixel values of the pixel positions at which the markers M811 to M813 are arranged, pixel values similar to each other in the selected partial image are extracted on the basis of the pixel values of the pixel positions at which the markers M821 and M822 are arranged, and process for dividing pixels in the selected partial image into additional target pixels and non-additional target pixels to binarize the pixels is performed. Then, the binarization result is displayed in the selection area display unit W81.

As a result, as shown in FIG. 31, a binary image representing the additional target pixels (white) and the non-additional target pixels (black) is displayed in the selection area display unit W81. When there is no problem in that the pixel positions to be added are in the area of the additional target pixels (white), the user clicks the OK button B83 to fix the selection operation of the pixel positions to be added. At this time, as internal process, process for specifying the pixels, which have been specified as the additional target pixels (white) in the binary image in the selection area display unit W81, as an additional target is performed (step f19 in FIG. 25: Yes). Thereafter, the additional spectrum information is registered on the basis of the pixel values of the specified pixels. When the pixel positions to be added are desired to be modified, the user performs the above operation by clicking again the additional target pixel selection button B81 or the non-additional target pixel selection button B82.

When the user clicks a pixel position on the display image or the selected partial image, it is possible to read corresponding pixel value of the VS image, display the spectrum information in a graph or the like, and present it to the user so as to support the selection operation of the pixel positions to be excluded or added. Here, although the selection operation of the pixel positions to be excluded and the selection operation of the pixel positions to be added are described individually, these selection operations may be performed on the same screen. For example, on the same screen on which the display image is displayed, it is possible to receive the selection operation of the pixel positions to be excluded, the selection operation of the pixel positions to be added, and the selection operation of the pixel positions not to be excluded or added, and specify the pixels to be excluded and the pixels to be added depending on content of the received user operation.

As described above, according to the third embodiment, the same effects as those of the first embodiment can be produced, and further it is possible to modify the result of the extraction of the extraction target structure which is performed by using the characteristic information of the extraction target structure recorded as the structure characteristic information 475 in the recording unit 47b in advance as teacher data. Specifically, pixels to be excluded are specified in accordance with a user operation, and the exclusion spectrum information is registered. Then, on the basis of the exclusion spectrum information, by determining whether the pixels extracted as the area of the extraction target structure are excluded from the extraction target structure or not for each pixel, the extraction result can be modified. Or, pixels to be added are specified in accordance with a user operation, and the additional spectrum information is registered. Then, on the basis of the additional spectrum information, by determining whether the pixels in the areas other than the extraction target structure are added as the area of the extraction target structure or not for each pixel, the extraction result can be modified. Therefore, even when the extraction target structure is not properly extracted due to individual difference between the target specimens S or the like, the extraction result can be modified in accordance with a user operation, so that extraction accuracy of the extraction target structure can be improved. At this time, the exclusion target map and the additional target map can be created on the basis of the extraction target map, so that it is not necessary to perform processing on all the pixels in the VS image. Since the extraction target map is not changed, it is possible to easily cancel the selection operation of the pixel positions to be excluded or added, and restore the original state.

The method for modifying the extraction result in accordance with a user operation is not limited to the method described above. For example, it is possible to modify the extraction result by using an identification machine such as a support vector machine (SVM). Specifically, for example, when specifying an additional target and adding pixels to be the area of the extraction target structure, learning identification process, which uses the pixel values of the pixel positions (pixel positions at which the markers M811 to M813 are arranged) selected on the selected partial image displayed in the selection area display unit W81 in FIG. 30 as a characteristic amount, is performed. The pixels to be added as the area of the extraction target structure may be extracted from pixels in areas other than the extraction target structure in the VS image by the learning identification process. Or, learning identification process, which uses the pixel values of the pixel positions (pixel positions at which the markers M821 and M822 are arranged) selected on the selected partial image as a characteristic amount, is performed. The pixels not to be added as the area of the extraction target structure may be extracted from pixels in areas other than the extraction target structure in the VS image by the learning identification process. In a similar way, the pixels to be excluded from the area of the extraction target structure may be extracted by using an identification machine such as an SVM.

Or, until the user determines that there is no pixels which are excessively extracted as the area of the extraction target structure or there is no extraction omission pixels which should have been the area of the extraction target structure, the learning identification process may be repeatedly performed while adjusting the threshold value used to determine whether or not a pixel is a pixel of the extraction target structure by, for example, a predetermined amount. The area of the extraction target structure in the VS image may be extracted by this learning identification process.

In the first embodiment or the like, a case in which the “highlight” is specified as the display method is described. On the other hand, in a fourth embodiment, a case in which the “non-display” is specified as the display method will be described. A device configuration according to the fourth embodiment can be realized by a similar configuration to the configuration of the microscope device 2 and the host system 4 according to the first embodiment, and the same reference numerals are given in the description below.

In the fourth embodiment, a structure desired not to be displayed is specified as the extraction target structure in step b1 which is shown in FIG. 12 and described in the first embodiment, and “non-display” is specified as the display method in step b3 in FIG. 12. In step b7 in FIG. 12, the structure extraction unit 455 performs the structure extraction process and extracts the specified extraction target structure, and in step b9 in FIG. 12, the display image generator 456 generates a display image in which the extracted extraction target structure is not displayed.

Structures that are desired not to be displayed during observation/diagnosis of the VS image include, for example, neutrophil which is an inflammatory cell. This is because the neutrophil is stained by dye H and has a navy blue color in a specimen on which the HE staining is performed, and when the neutrophil is on a structure desired to be observed, the visibility of the structure to be observed/diagnosed deteriorates, and the diagnosis may be hindered.

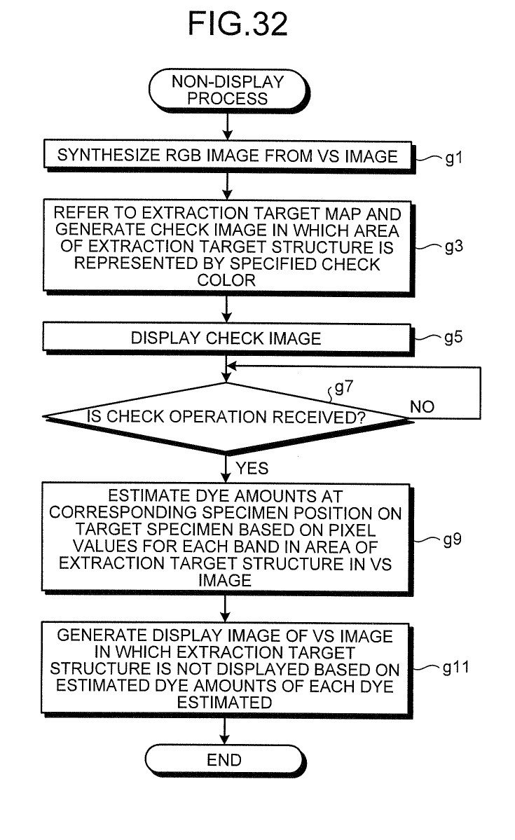

Therefore, in the fourth embodiment, the display image generator 456 performs the non-display process as process in step b9 in FIG. 12, and generates a display image in which the extraction target structure appearing in the VS image is not displayed. FIG. 32 is a flowchart showing a detailed processing procedure of the non-display process performed here. In the description below, for the sake of simplicity, it is assumed that one extraction target structure is specified, and “non-display” is specified as the display method thereof.

In the non-display process, as shown in FIG. 32, the display image generator 456, first, synthesizes an RGB image from the VS image by using spectral sensitivities of each of R, G, and B bands in order to display and check the extraction result of the structure extraction process (step g1). Next, the display image generator 456 refers to the extraction target map created in the structure extraction process, and generates a check image in which the area of the extraction target structure in the synthesized RGB image is represented by a specified check color (step g3). Specifically, the display image generator 456 generates the check image by replacing the pixel values of the pixel positions for which “1” is set in the extraction target map by the specified check color.

Then, the display image generator 456 performs process for displaying the check image generated in step g3 on the display unit 43 (step g5), and thereafter waits in a stand-by state until a check operation is received (step g7: No).

When the display image generator 456 receives the check operation of a user (step g7: Yes), as a spectral component amount reception unit, the display image generator 456 estimates dye amounts at a corresponding specimen position on the target specimen S on the basis of pixel values for each band for each pixel in the area of the extraction target structure in the VS image in accordance with the extraction target map (step g9).

Processing procedure will be briefly described. First, the display image generator 456 estimates a spectrum (estimated spectrum) at each corresponding specimen position on the target specimen S for each pixel on the basis of the pixel values in the VS image. For example, as described in the process in step c5 in FIG. 14, the display image generator 456 calculates spectral absorbances for each wavelength λ for each pixel in the VS image in accordance with equation (1) described in the first embodiment. The calculated spectral absorbances are obtained as the estimated spectrum. The method for estimating spectrum from a multiband image is not limited to this, but for example, Wiener estimation may be used. Next, the display image generator 456 estimates (calculates) a dye amount of the target specimen S for each pixel by using a reference dye spectrum for each dye which stains the target specimen S in advance.

The estimation of dye amount can be performed by, for example, applying the publicly known technique described in Japanese Laid-open Patent Publication No. 2008-51654 mentioned in Description of the Related Art. Here, the estimation of dye amount will be briefly described. It is known that, generally, a material that transmits light follows Lambert-Beer law represented by equation (2) described below between the strength of incoming light I₀(λ) for each wavelength λ, and the strength of outgoing light I(λ). k(λ) represents a value which is unique to the material and determined depending on wavelength, and d represents a depth of the material. The left-hand side of equation (2) indicates a spectral transmittance t(λ).

$$\frac{I ( λ )}{{I}_{0} ( λ )} = {e}^{- k ( λ ) \cdot d} \qquad ( 2 )$$

For example, when the specimen is stained by n types of dyes dye 1, dye 2, . . . , dye n, the following equation (3) is established for each wavelength λ by Lambert-Beer law.

$$\frac{I ( λ )}{{I}_{0} ( λ )} = {e}^{- ( {k}_{1} ( λ ) \cdot {d}_{1} + {k}_{2} ( λ ) \cdot {d}_{2} + … + {k}_{n} ( λ ) \cdot {d}_{n} )} \qquad ( 3 )$$

k₁(λ), k₂(λ), . . . , kₙ(λ) respectively represent k(λ) corresponding to dye 1, dye 2, . . . , dye n, and for example, they are reference dye spectra of each dye which stains the specimen. d₁, d₂, dₙ represent virtual thicknesses of the dye 1, dye 2, . . . , dye n at specimen positions on the target specimen S corresponding to each image position of the multiband image. Naturally, dyes are present in a distributive manner in a specimen, so that the concept of thickness is not correct. However, the thickness can be a relative indicator representing what amount of dye is contained compared with a case in which the specimen is assumed to be stained with a single dye. In other words, it can be said that d₁, d₂, . . . , dₙ respectively represent dye amounts of the dye 1, dye 2, . . . , dye n. k₁(λ), k₂(λ), . . . , kₙ(λ) can be easily obtained from Lambert-Beer law by preparing specimens stained with each dye of dye 1, dye 2, . . . , dye n respectively in advance, and measuring spectral transmittances thereof by a spectrometer.

In the fourth embodiment, a specimen on which the HE staining is performed is used as the target specimen S, and thus, for example, hematoxylin (dye H) is assigned to the dye 1 and eosin (dye E) is assigned to the dye 2. When a specimen on which the Pap staining is performed is used as the target specimen S, a dye used in the Pap staining may be assigned. In addition to absorbing components of these dyes, in the target specimen S, there may be a tissue having an absorbing component without staining such as a red blood cell. Specifically, the red blood cell has a color unique thereto even when it is not stained, and the red blood cell is observed as the color of its own after the HE staining is performed. Or, the red blood cell is observed in a state in which the color of eosin changed in the staining process is superimposed on the color of the red blood cell itself. The absorbing component of the red blood cell is assigned to the dye 3. In the fourth embodiment, for each structure which can be specified as the extraction target structure, dye information of the extraction target structure in a specimen on which the HE staining is performed (colors in which hematoxylin and eosin are superimposed on the extraction target structure) is modeled, and the reference dye spectrum k(λ) thereof is determined in advance. The dyes modeled for the specified extraction target structures are assigned to the dye 4 and following dyes. When one extraction target structure not to be displayed is specified as described in this example, the dye information of the extraction target structure not to be displayed is assigned to the dye 4.

The dye amounts of the dyes 1 to 4 described above actually correspond to component amounts for each predetermined spectral component of a spectrum (here, estimated spectrum) at each specimen position on the target specimen S. Specifically, in the above example, a spectrum at each specimen position on the target specimen S includes four spectrum components of dye H, dye E, dye R, and the extraction target structure, the spectrum components are respectively referred to as reference dye spectra (kₘ(λ)) of the dyes 1 to 4, and the component amounts thereof are referred to as dye amounts.

When taking the logarithm of both sides of the equation (3), the following equation (4) is obtained.

$$- log \frac{I ( λ )}{{I}_{0} ( λ )} = {k}_{1} ( λ ) \cdot {d}_{1} + {k}_{2} ( λ ) \cdot {d}_{2} + … + {k}_{n} ( λ ) \cdot {d}_{n} \qquad ( 4 )$$

When an element corresponding to the wavelength λ of the estimated spectrum estimated for each pixel of the VS image is defined as \hat{t}(x, λ) indicating an estimated value, and this is substituted in the equation (4), the following equation (5) is obtained.

−log \hat{t}(x,λ)=k₁(λ)·d₁+k₂(λ)·d₂+ . . . +kₙ(λ)·dₙ (5)

There are n unknown variables d₁, d₂, . . . , dₙ in equation (5). Hence, when at least n simultaneous equations (5) are used for at least n different wavelengths λ, the simultaneous equations can be solved. To further improve accuracy, n or more simultaneous equations (5) may be used for n or more different wavelengths λ, and a multiple regression analysis may be performed.

The above is the simple procedure of the dye amount estimation, and n=4 in the example described above. The display image generator 456 estimates dye amounts of H dye, E dye, and the absorbing component of red blood cell fixed to corresponding specimen positions, and a dye of the extraction target structure which is not displayed on the basis of the estimated spectrum estimated for each pixel of the VS image.

As shown in FIG. 32, the display image generator 456 generates a display image of the VS image in which the extraction target structure is not displayed on the basis of the estimated dye amounts of each pixel. Specifically, the display image generator 456 newly calculates RGB values of each pixel in the area of the extraction target structure on the basis of the dye amounts of dyes estimated for each pixel in the area of the extraction target structure in the VS image. Then, the display image generator 456 replaces pixel values of the pixels in the area of the extraction target structure in the RGB image synthesized in step g1 by the newly calculated RGB values, and generates a display image of the VS image. Pixel values of pixels outside the area of the extraction target structure are the pixel values of the RGB image synthesized in step g1. Here, the process for converting the dye amounts into the RGB values can be performed by, for example, applying the publicly known technique described in Japanese Laid-open Patent Publication No. 2008-51654.

Processing procedure will be briefly described. First, the calculated dye amounts of each dye d₁, d₂, . . . , dₙ are multiplied by correction coefficients α₁, α₂, . . . , αₙ respectively, the obtained values are substituted into equation (3), and equation (6) described below is obtained. At this time, in this example, the correction coefficients αₙ (n=1 to 3) which are multiplied to the dyes 1 to 3 assigned to dye H, dye E, and the absorbing component of red blood cell are set to “1”, and the correction coefficient αₙ (n=4) which is multiplied to the dye 4 assigned to the extraction target structure that is not displayed is set to “0”, and hence a spectral transmittance t*(x, λ) targeting the dye amounts of the dyes 1 to 3 other than the dye 4 of the extraction target structure that is not displayed is obtained. When a plurality of extraction target structures that are not displayed are specified, the correction coefficients αₙ which are multiplied to dyes assigned to each extraction target structure are set to “0”. When a plurality of extraction target structures are specified, and the extraction target structures that are not displayed and the extraction target structures that are highlighted are specified in a mixed state, only the correction coefficients αₙ of the extraction target structures that are not displayed are set to “0”.

t*(x,λ)=e^{(k}^{₁}^{(λ)·α}^{₁}^{d}^{₁}^{+k}^{₂}^{(λ)·α}^{₂}^{d}^{₂}^{+ . . . +k}^{ₙ}^{(λ)·α}^{ₙ}^{d}^{ₙ}⁾ (6)

With respect to a given point (pixel) x in a captured multiband image, a relationship of equation (7) below based on a camera response system is established between a pixel value g (x, b) in, band b and the spectral transmittance t*(x, λ) of a corresponding point on a specimen.

$$g ( x , b ) = {\int }_{λ} f ( b , λ ) s ( λ ) e ( λ ) t ( x , λ ) d λ + n ( b ) \qquad ( 7 )$$

λ represents a wavelength, f(b, λ) represents a spectral transmittance of b-th filter, s(λ) represents a spectral sensitivity characteristic of camera, e(λ) represents a spectral radiation characteristic of illumination, and n(b) represents observation noise in band b. b is a serial number for identifying band, and here, b is an integer satisfying 1≦b≦6.

Therefore, by substituting equation (6) into equation (7) described above and obtaining pixel values, it is possible to obtain pixel values of the display image in which dye amount of dye 4 of the extraction target structure is not displayed (a display image representing a staining state of the dyes 1 to 3 except for the dye 4). In this case, the pixel values can be calculated assuming that the observation noise is zero.

When the non-display process has been performed as described above, then, the VS image display processing unit 454 performs process for displaying the generated display image on the display unit 43 in the same way as in step b11 shown in FIG. 12 and described in the first embodiment.

As described above, according to the fourth embodiment, it is possible not to display the area of the extraction target structure by specifying a structure that deteriorates visibility of the structure to be observed/diagnosed and hinders the diagnosis as the extraction target structure. For example, when neutrophil is contained in the target specimen S and the neutrophil hides the structure to be observed/diagnosed to deteriorate the visibility, it is possible not to display the neutrophil by specifying “neutrophil” as the extraction target structure and specifying “non-display” as the display method thereof. Therefore, it is possible to present an image in which a structure that hinders diagnosis is excluded and the visibility of the target specimen S is improved to a user. The user can avoid overlooking an abnormal finding because the user can exclude desired structure that is unnecessary for observation/diagnosis and can observe the target specimen S with good visibility. Therefore, the diagnostic accuracy can be improved.

Also in the fourth embodiment, in the same way as in the modified example described in the first embodiment, only pixels in a predetermined area of the VS image may be determined whether or not to be the extraction target structure to shortening the processing time. For example, before extracting the extraction target structure, an RGB image to be displayed may be synthesized from the VS image and displayed, and an area selection by a user may be received. Also, the pixels in the area selected by the user using a mouse included in the input unit 41 may be determined whether or not to be the extraction target structure. Based on this, it is possible to extract an extraction target structure in which an area that is determined to have bad visibility by the user is not displayed, and the extraction target structure in this area can be not displayed.

In the fourth embodiment described above, the correction coefficient αₙ applied to the extraction target structure not to be displayed is set to “0”. On the other hand, the dye amount dₙ of the dye assigned to the extraction target structure not to be displayed may be set to “0” to generate the display image.

In the fourth embodiment described above, although a case is described in which a structure such as neutrophil which hinders observation is not displayed, it is not limited to “non-display”, but, for example, it is possible to change the color of the structure to a pale color or reduce the color density to improve visibility of the structure to be observed/diagnosed.

When changing color, a spectral characteristic of a predetermined pseudo display color is defined in advance. Then, RGB values are calculated by using the spectrum of the pseudo display color as the reference dye spectrum of the dye assigned to the extraction target structure not to be displayed. Specifically, spectrum estimation is performed by replacing the reference dye spectrum k(λ) of the dye of the extraction target structure substituted into equation (6) described above by the spectrum of the pseudo display color, and the RGB values are calculated by the estimation result.

When reducing the color density, an arbitrary value smaller than or equal to “1” may be set to the correction coefficient αₙ applied to the specified extraction target structure. At this time, by applying the method described in the second embodiment, the residual difference value may be obtained for each pixel in the extraction target structure. Also, the value of the correction coefficient αₙ may be set in accordance with the residual difference value. Specifically, on the basis of the residual difference value, the smaller the residual difference is and the higher the possibility to be the extraction target structure is, the smaller the value of the correction coefficient αₙ may be set to near “0” so that the color density may be reduced. On the other hand, the larger the residual component is and the lower the possibility to be the extraction target structure is, the larger the value of the correction coefficient αₙ may be set to near “1”.

As the types of special staining, for example, Elastica van Gieson staining, HE-alcian blue staining, Masson trichrome staining, and the like are known, and structures to be stained are different depending the type of staining. Therefore, in a fifth embodiment, a structure to be actually stained by special staining is defined to be associated with one of the special stainings in advance. A structure defined to be associated with a special staining specified in accordance with a user operation is automatically set as the extraction target structure. In the description below, two types of special staining, Elastica van Gieson staining and Masson trichrome staining, are explained.

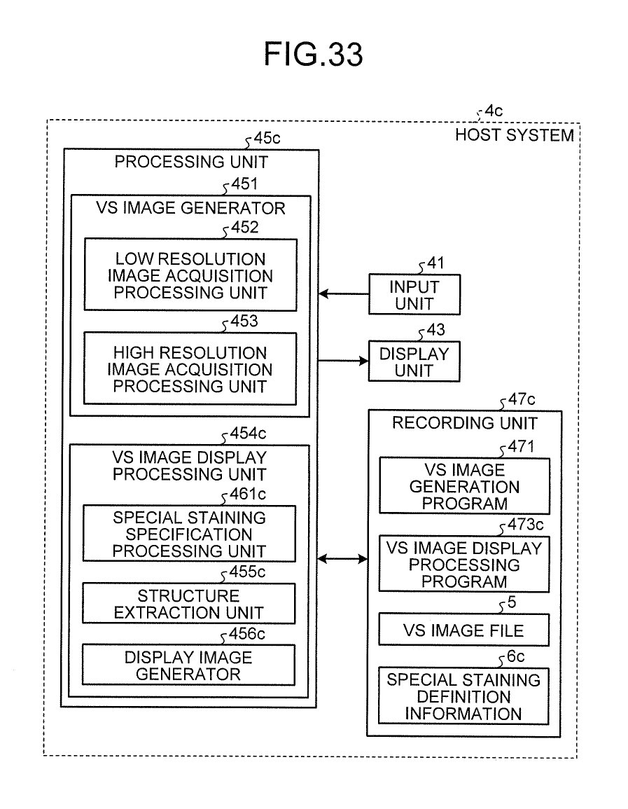

FIG. 33 is a diagram showing main functional blocks of a host system 4c according to the fifth embodiment. The same reference numerals are given to the same components as those described in the first embodiment. As shown in FIG. 33, the host system 4c included in a microscope system according to the fifth embodiment includes the input unit 41, the display unit 43, a processing unit 45c, a recording unit 47c, and the like.

A VS image display processing unit 454c in the processing unit 45c includes a special staining specification processing unit 461c as a staining type specifying unit, a structure extraction unit 455c, and a display image generator 456c. The special staining specification processing unit 461c specifies a type of special staining in accordance with a user operation by automatically setting a structure defined to be associated with the specified special staining as the extraction target structure. Meanwhile, in the recording unit 47c, a VS image display processing program 473c for causing the processing unit 45c to function as the VS image display processing unit 454c and the like are recorded. In the fifth embodiment, the recording unit 47c records special staining definition information 6c, which is an example of staining type definition information, as a definition information recording unit.

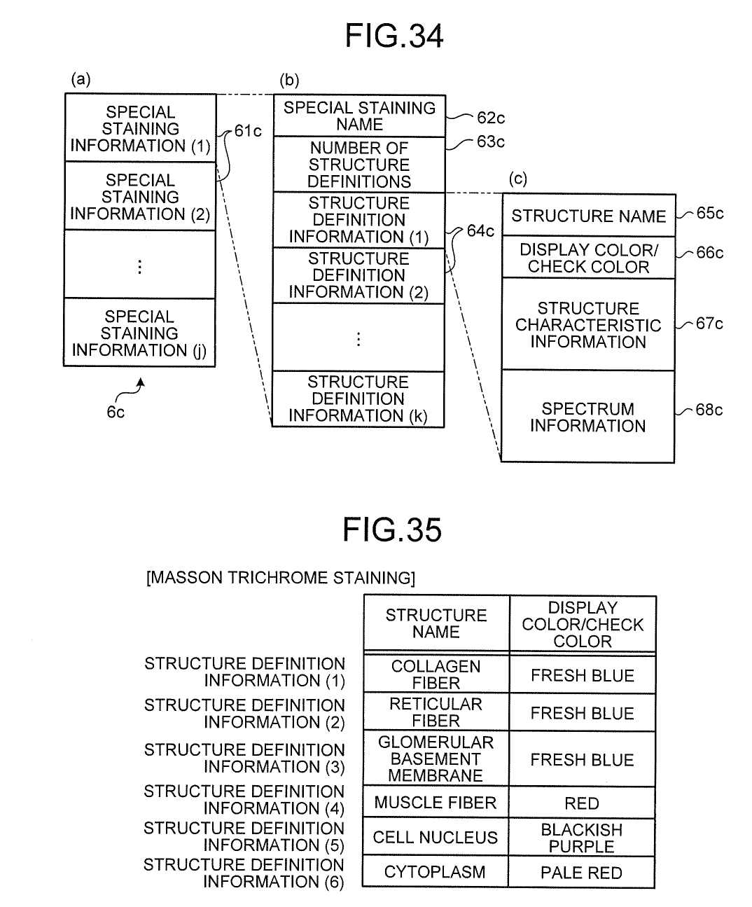

FIG. 34 is a diagram showing a data configuration example of the special staining definition information. As shown in (a) of FIG. 34, in the special staining definition information 6c, special staining information items (1) to (j) 61c for each type of special staining defined to be associated with a staining target structure. In this example, since structures are defined to be associated with two staining types of Masson trichrome staining and Elastica van Gieson staining, j=2, and two special staining information items 61c are set. The number or types of special stainings to be defined is not limited to this, but can be set as necessary.

As shown in (b) of FIG. 34, j special staining information items 61c respectively include a special staining name 62c, the number of structure definitions 63c, and structure definition information items (1) to (k) 64c. The number of structure definitions 63c is the number of the structure definition information items 64c recorded in the corresponding special staining information 61c, and corresponds to k. As shown in (c) of FIG. 34, k structure definition information items 64c respectively include a structure name 65c, display color/check color 66c, structure characteristic information 67c, and spectrum information 68c.

FIG. 35 is a diagram showing an example of a structure defined to be associated with Masson trichrome staining. In an example of FIG. 35, regarding the Masson trichrome staining, six types of structures “collagen fiber”, “reticular fiber”, “glomerular basement membrane”, “muscle fiber”, “cell nucleus”, and “cytoplasm” are defined. In this case, in the special staining information 61c, “Masson trichrome staining” is set to the special staining name 62c, and “6” is set to the number of structure definitions 63c. In each structure definition information item 64c, the six types of structures are respectively set in the structure name 65c, and spectral characteristics of colors (reference dye spectra) shown in a table of FIG. 35 are respectively set in the corresponding display color/check color 66c. Also, in the structure characteristic information 67c, in the same manner as in the first embodiment, predefined characteristic information is set for a corresponding structure. In the spectrum information 68c, a spectral characteristic predefined for the structure is set. Specifically, in the same manner as in the fourth embodiment, dye information of a corresponding structure in a specimen on which the HE staining is performed (colors of hematoxylin and eosin are superimposed on the structure) is modeled in advance so as to set the reference dye spectrum.

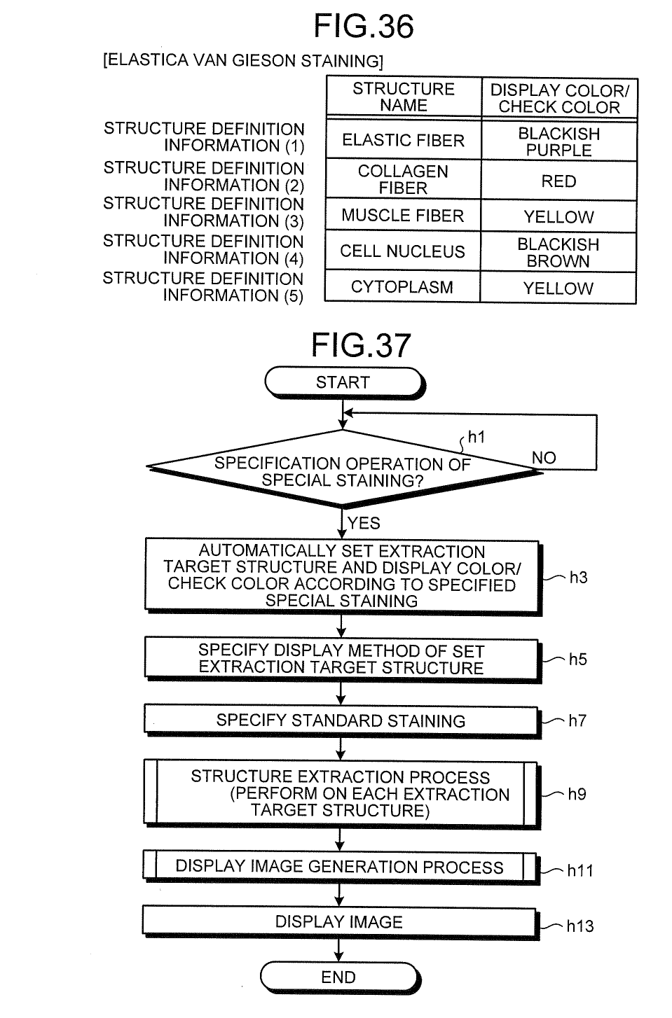

On the other hand, FIG. 36 is a diagram showing an example of a structure defined for Elastica van Gieson staining. In an example of FIG. 36, regarding the Elastica van Gieson staining, five types of structures “elastic fiber”, “collagen fiber”, “muscle fiber”, “cell nucleus”, and “cytoplasm” are defined. In this case, in the special staining information 61c, “Elastica van Gieson staining” is set to the special staining name 62c, and “5” is set to the number of structure definitions 63c. In each structure definition information item 64c, the five types of structures are respectively set in the structure name 65c, and spectral characteristics of colors shown in the table of FIG. 36 are respectively set in the corresponding display color/check color 66c. Also, in the structure characteristic information 67c, in the same manner as in the first embodiment, predefined characteristic information is set for a corresponding structure, and in the spectrum information 68c, a spectral characteristic predefined for the structure is set.

FIG. 37 is a flowchart showing a processing procedure of VS image display process according to the fifth embodiment. The processing described here is realized by the VS image display processing unit 454c reading and executing the VS image display processing program 473c recorded in the recording unit 47c.

In the fifth embodiment, as shown in FIG. 37, first, the special staining specification processing unit 461c receives a specification operation of the type of special staining. When the specification operation of special staining is performed (step h1: Yes), as process in step h3, first, the special staining specification processing unit 461c refers to the special staining information 61c in the special staining definition information 6c related to the specified special staining (special staining name specified in the special staining name 62c is the set special staining information 61c), and reads the structure name 65c and the display color/check color 66c respectively from the structure definition information items (1) to (k) 64c of the specified special staining. Then, the special staining specification processing unit 461c automatically sets the extraction target structure and the display color/check color on the basis of the read structure name 65c and the display color/check color 66c (step h3). Also, in accordance with a user operation, the VS image display processing unit 454c specifies the display method of the extraction target structure automatically set in step h3 (step h5), and specifies the type of the standard staining performed on the target specimen S (step h7).

For example, the VS image display processing unit 454c performs process for displaying a special staining specifying screen on the display unit 43 and notifying of a specification request related to the extraction target structure and the display thereof, and receives a specification operation of the special staining, the display method of the extraction target structure according to the special staining, the standard staining, and the like on the special staining specifying screen.

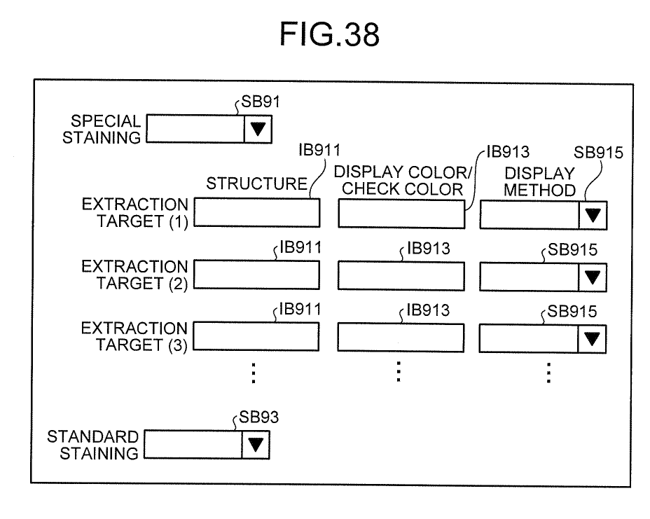

FIG. 38 is a diagram showing an example of the special staining specifying screen. As shown in FIG. 38, on the special staining specifying screen, a spin box SB91 for specifying the type of special staining and a spin box SB93 for specifying the type of standard staining are arranged. Here, the spin box SB91 presents a list of the special staining as options, and prompts to specify the special staining. In this example, Masson trichrome staining and Elastica van Gieson staining are presented as the options. In the lower portion of the spin box SB91, an input box IB911 into which the extraction target structure is inputted, an input box IB913 into which the display color/check color is inputted, and a spin box SB915 for specifying the display method are arranged.

For example, in the spin box SB91, a user specifies a special staining which stains a structure which the user desires to observe. As a result, as internal process, process in step h3 is performed. Thus the special staining specification processing unit 461c refers to the special staining definition information 6c, and automatically sets the extraction target structure and the display color/check color. For example, when the Elastica van Gieson staining is specified, as illustrated in FIG. 36, five types of structures “elastic fiber”, “collagen fiber”, “muscle fiber”, “cell nucleus”, and “cytoplasm” defined in the special staining information 61c are set as the extraction target structure. In this case, these five types of structures are automatically inputted into each input box IB911 of the extraction target structures (1), (2), (3), . . . and so on in FIG. 38, and the display color/check color thereof is automatically inputted into corresponding input box IB913, and thus they are presented to the user.

For example, the user specifies the display method of each extraction target structure in the spin box SB915, and specifies the standard staining in the spin box SB93. Here, the display method of each extraction target structure is set manually. On the other hand, for example, the display method may be automatically set with the initial value being “highlighted display”. When there is an extraction target structure not necessary for the user to observe in the five types of extraction target structures that are automatically set, it is possible to manually specify the “non-display” as necessary.

Next, as shown in FIG. 37, the structure extraction unit 455c performs the structure extraction process in the same manner as in the first embodiment (step h9). In the fifth embodiment, while sequentially targeting all the extraction target structures automatically set in step h3, the structure extraction unit 455c performs the structure extraction process. Specifically, the structure extraction unit 455c refers to the special staining information 61c related to the specified special staining, and reads the structure characteristic information 67c set in the structure definition information 64c of the extraction target structure to be processed, and thus the structure extraction unit 455c uses the structure characteristic information 67c as teacher data. Then, the structure extraction unit 455c extracts an area covering each extraction target structure individually from the VS image of the target specimen S, and creates an extraction target map for the extraction target structure to be processed. At this time, by applying the method described in the second embodiment, the structure extraction unit 455c calculates the residual difference values for each pixel in the extraction target structure, and records the residual difference values in the recording unit 47c.

Next, the display image generator 456c performs the display image generation process (step h11). The VS image display processing unit 454c performs process for displaying the display image generated in step h11 on the display unit 43 (step h13).

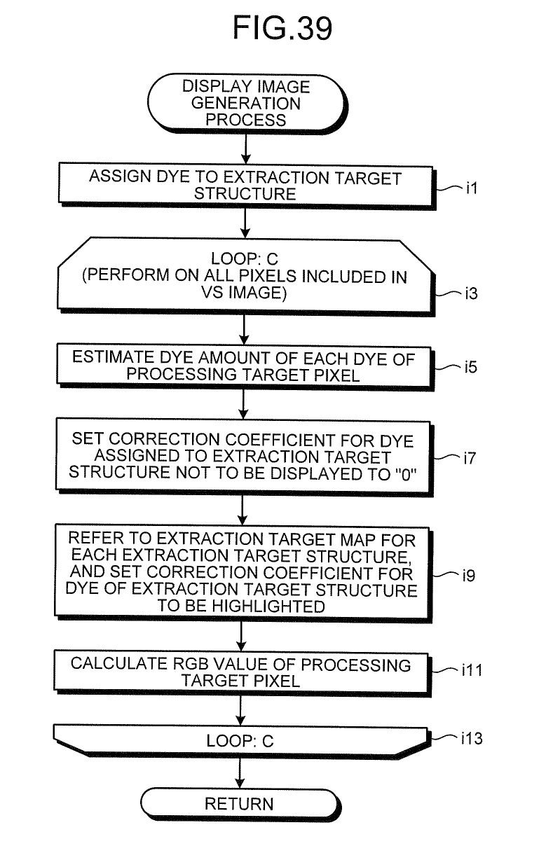

Here, the display image generation process in step h11 will described. FIG. 39 is a flowchart showing a detailed processing procedure of the display image generation process according to the fifth embodiment.

As shown in FIG. 39, in the display image generation process, first, the display image generator 456c assigns dye 1, dye 2, . . . , dye n to the dye which stains the target specimen S and each structure automatically set as the extraction target structure in step h3 in FIG. 37 (step i1). Specifically, in the fifth embodiment, a specimen on which the HE staining is performed is used as the target specimen S, and thus, in the same manner as in the fourth embodiment, the dye H is assigned to the dye 1, the dye E is assigned to the dye 2, and the absorbing component of the red blood cell is assigned to the dye 3. The dye 4 and following dyes are assigned to each structure automatically set as the extraction target structure. For example, in the same way as in the example described above, when the Elastica van Gieson staining is specified in the special staining specifying screen, and five types of structures “elastic fiber”, “collagen fiber”, “muscle fiber”, “cell nucleus”, and “cytoplasm” are automatically set as the extraction target structure, the dye information of the “elastic fiber” is assigned to the dye 4, the dye information of the “collagen fiber” is assigned to the dye 5, the dye information of the “muscle fiber” is assigned to the dye 6, the dye information of the “cell nucleus” is assigned to the dye 7, and the dye information of the “cytoplasm” is assigned to the dye 8.

Next, while sequentially targeting each pixel included in the VS image, the display image generator 456c performs processing of loop C on all the pixels included in the VS image (step i3 to step i13).

In the loop C, first, the display image generator 456c estimates a dye amount of each dye assigned to the processing target pixel in step i1 (step i5). Specifically, the display image generator 456c estimates the dye amount by applying the above described equations (1) to (5) in the same manner as in the fourth embodiment. At this time, the display image generator 456c refers to the special staining information 61c related to the specified special staining, reads the spectrum information 68c of each structure, and uses the spectrum information 68c as the reference dye spectrum kₙ(λ). For example, in the same way as in the example described above, when the dye information of dye H, dye E, the absorbing component of red blood cell, and the five types of structures defined for Elastica van Gieson staining is assigned to the dyes 1 to 8 in step i1, the display image generator 456c estimates the dye amounts of the dyes 1 to 8.

In the same manner as in the fourth embodiment, the dye amounts of the dyes 1 to 8 described above actually correspond to component amounts for each predetermined spectral component of a spectrum at each specimen position on the target specimen S. In other words, in the fifth embodiment, a spectrum at each specimen position on the target specimen S is constituted by spectral components of the structures automatically set as dye H, dye E, dye R, and the extraction target components. Each of the spectral components is respectively referred to as reference dye spectrum kₘ(λ) of the dyes 1 to 8, and the component amount thereof is referred to as dye amount. A spectrum at each specimen position on the target specimen S may be constituted by spectral components of the structures automatically set as the extraction target components. In this case, for example, in a case of Elastica van Gieson staining, the dye information of “elastic fiber” is assigned to dye 1, the dye information of “collagen fiber” is assigned to dye 2, the dye information of “muscle fiber” is assigned to dye 3, the dye information of “cell nucleus” is assigned to dye 4, and the dye information of “cytoplasm” is assigned to dye 5.

Next, when there is an extraction target structure not to be displayed, the display image generator 456c sets the correction coefficient αₙ for the dye assigned to the extraction target structure to “0” on the basis of the display method specified in step h5 in FIG. 37 (step i7)

The display image generator 456c refers to the extraction target maps obtained for each extraction target structure in step h9 in FIG. 37, and sets the correction coefficient αₙ for the dye of the extraction target structure to be highlighted (step i9). Specifically, the display image generator 456c sequentially refers to the extraction target maps of the extraction target structures to be highlighted, and when the processing target pixel is not extracted as the area of the extraction target structure, the display image generator 456c sets the correction coefficient αₙ for the dye assigned to the extraction target structure to “0”. On the other hand, when the processing target pixel is extracted as the area of the extraction target structure, the display image generator 456c sets the correction coefficient αₙ for the dye assigned to the extraction target structure to a value corresponding to the residual difference value obtained for the processing target pixel. Specifically, the smaller the residual difference is and the higher the possibility to be the extraction target structure is, the larger the value of the correction coefficient αₙ is set to near “1”. On the other hand, the larger the residual difference is and the lower the possibility to be the extraction target structure is, the smaller the value of the correction coefficient αₙ is set to near “0”.

The display image generator 456c calculates the RGB value of the processing target pixel (x) by applying the above described equations (6) and (7) in the same manner as in the fourth embodiment (step ill). At this time, the display image generator 456c refers to the special staining information 61c related to the specified special staining, reads the display color/check color 66c of each structure, and uses the display color/check color 66c as the kₙ(λ) to replace the display color in a pseudo manner. Thereafter, the display image generator 456c ends the processing of loop C for the processing target pixel. When the display image generator 456c completes the processing of loop C for all the processing target pixels that are all the pixels included in the VS image, the process returns to step h11 in FIG. 37.

According to the fifth embodiment, it is possible to specify a type of special staining in accordance with a user operation and automatically set a structure based on the specified special staining as the extraction target structure. Also, it is possible to estimate the dye amount of the set structure and display the structure with the display color preliminarily set for the structure, and thus an image appearing as if the specified special staining was performed on the structure can be presented to the user.

Also, in the fifth embodiment, by using the display color/check color 66c set in the special staining information 61c, in the same manner as for the non-display process in the fourth embodiment, a check image in which the area of the extraction target structure is displayed with the specified check color in advance may be displayed.

In the fifth embodiment described above, a structure is defined in accordance with a type of special staining in advance. On the other hand, a combination of structures and the display color/check color thereof may be registered in accordance with a user operation. The extraction target structure may be specified in accordance with the registered combination of structures. Based on this, by registering a desired combination of structures and the display color/check color thereof, the user can observe these structures with good visibility.

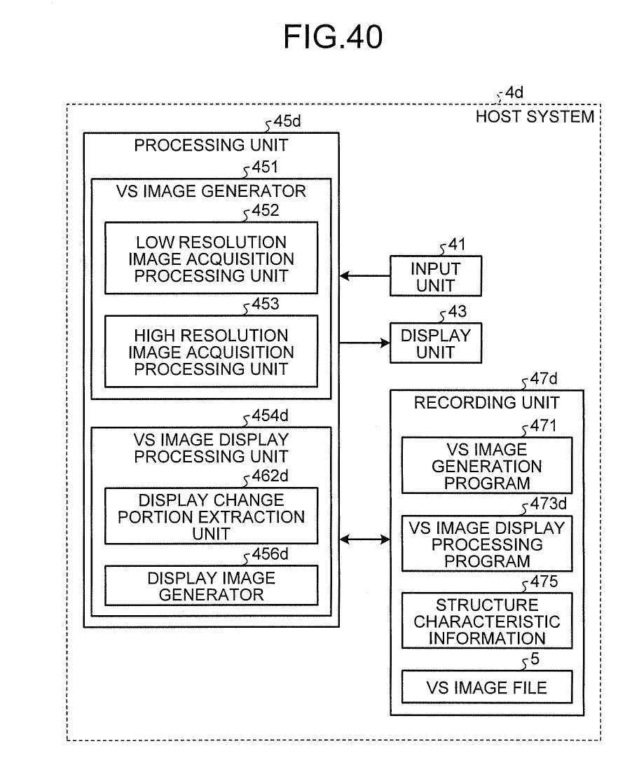

FIG. 40 is a diagram showing main functional blocks of a host system 4d according to a sixth embodiment. The same reference numerals are given to the same components as those described in the first embodiment. As shown in FIG. 40, the host system 4d included in a microscope system according to the sixth embodiment includes the input unit 41, the display unit 43, a processing unit 45d, a recording unit 47d, and the like.

A VS image display processing unit 454d in the processing unit 45d includes a display change portion extraction unit 462d and a display image generator 456d. The display change portion extraction unit 462d specifies a display change position in the VS image in accordance with a user operation, and extracts a portion appearing at the specified display change position as a display change portion. In the recording unit 47d, a VS image display processing program 473d for causing the processing unit 45d to function as the VS image display processing unit 454d and the like are recorded.

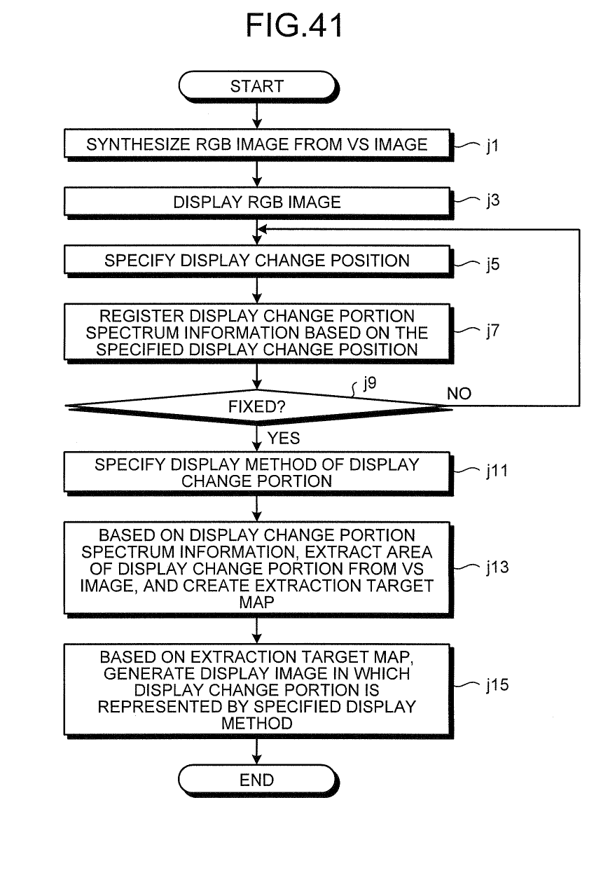

FIG. 41 is a flowchart showing a processing procedure of VS image display process according to the sixth embodiment. The processing described here is realized by the VS image display processing unit 454d reading and executing the VS image display processing program 473d recorded in the recording unit 47d.

In the sixth embodiment, as shown in FIG. 41, first, the VS image display processing unit 454d synthesizes an RGB image from the VS image by using spectral sensitivities of each of R, G, and B bands (step j1), and performs process for displaying the synthesized RGB image on the display unit 43 (step j3).

Next, the display change portion extraction unit 462d specifies a display change position in accordance with a user operation (step j5). For example, the display change portion extraction unit 462d receives a selection operation of a pixel position on the RGB image displayed in step j3, and specifies the selected pixel position as the display change position. While looking at the RGB image synthesized from the VS image, the user clicks, for example, a pixel position at which a structure desired to be highlighted appears, or clicks a pixel position at which a structure desired not to be displayed appears to specify the display change position.

Then, the display change portion extraction unit 462d reads pixel values for each band (each wavelength λ) of the pixel specified as the display change position from the image data 58 (refer to FIG. 11) in the VS image file 5, and registers the pixel values as display change portion spectrum information (step j7). When a plurality of display change positions is specified, the pixel values of each pixel position are respectively registered as the display change portion spectrum information.

Thereafter, until the operation is fixed (step j9: No), the process returns to step j5. When the operation is fixed (step j9: Yes), the VS image display processing unit 454d specifies the display method of the display change portion appearing at the display change position in accordance with a user operation (step j11). At this time, the VS image display processing unit 454d specifies the display color or the check color along with the display method in accordance with a user operation.

Then, the display change portion extraction unit 462d extracts an area of the display change portion from the VS image and creates an extraction target map in which a determination result indicating whether not the area is the display change portion is set by using the display change portion spectrum information registered in step j7 as a reference spectrum (teacher data) (step j13). Specifically, while sequentially targeting each pixel included in the VS image, the display change portion extraction unit 462d sequentially determines whether or not the pixel is the pixel of the display change portion. As the processing procedure, for example, the method described in the third embodiment can be applied. Specifically, first, the display change portion extraction unit 462d compares the pixel values for each band (for each wavelength λ) of the processing target pixel and extraction portion spectrum information, obtains differences between the pixel values and the extraction portion spectrum information for each wavelength λ, and calculates the sum of squares of the obtained differences. Then, the display change portion extraction unit 462d performs threshold processing on the calculated value by using a predetermined threshold value set in advance, and for example, determines that the processing target pixel is the display change portion when the calculated value is smaller than the threshold value.

When the extraction target map is created in the manner described above, next, the display image generator 456d generates a display image in which the display change portion in the target specimen S is represented by the specified display method on the basis of the extraction target map (step j15). When the specified display method is the “highlight”, the display image generator 456d applies the method described in the first embodiment, and generates the display image by replacing the pixel values of each pixel determined to be the display change portion by the specified display color. When the specified display method is the “non-display”, the display image generator 456d applies the method described in the fourth embodiment to estimate dye amounts of each dye at each specimen position on the target specimen S, and generates the display image of the VS image in which the extraction target structure is not displayed on the basis of the estimated dye amounts of the pixels.

As described above, according to the sixth embodiment, a display change position in the VS image can be specified in accordance with a user operation. On the basis of the pixel value of the specified display change position, a pixel having a similar spectrum to that of the specified display change position can be extracted from the VS image as a pixel of the display change portion appearing at the display change position. As a result, a structure appearing at the display change position can be extracted as the display change portion. Therefore, regarding a structure whose characteristic information is not defined in the structure characteristic information 475 in advance, it is possible to present an image in which the area of the structure is represented by the specified display method to a user. By specifying a pixel position at which a structure desired to be highlighted appears as the display change position, for example, and specifying “highlight” as the display method thereof, a user can easily distinguish the area of the structure (display change portion) from other areas. Or, by specifying a pixel position at which a structure desired not to be displayed as the display change position, and specifying “non-display” as the display method thereof, a user can observe the target specimen S with good visibility while eliminating the structure (display change portion) not necessary for the observation/diagnosis.

In the embodiments described above, the type of staining is specified in accordance with a user operation. On the other hand, by applying the method described in the fourth embodiment and using the technique of Japanese Laid-open Patent Publication No. 2008-51654, the dye amount of the dye which stains the target specimen S may be estimated. The type of the standard staining which stains the target specimen S may be automatically determined on the basis of the estimated dye amount. Specifically, for example, one or a plurality of pixels is selected in accordance with a user operation. Then, whether or not the dye H and the dye E are included in the dye which stains the target specimen S is determined on the basis of the estimated dye amount of the dye H and the dye E on a specimen position on the target specimen S corresponding to the selected pixel position. When the dye H and the dye E are included, it is automatically determined that the standard staining performed on the target specimen S is the HE staining. Other standard staining such as the Pap staining can be determined by the same method as described above.

The present invention is not limited to the embodiments described above, but various inventions can be formed by properly combining a plurality of constituent elements disclosed in the above embodiments. For example, the invention may be formed by removing some of the constituent elements from all the constituent elements shown in the above embodiments. Or, the invention may be formed by properly combining constituent elements shown in different embodiments.

According to the microscope system, the specimen observation method, and the computer program product of the present invention, it is possible to specify a structure in a specimen as an extraction target structure, specify a display method of the extraction target structure, and generate a display image in which the specified extraction target structure in the specimen is represented by the specified display method. Therefore, it is possible to present an image showing a desired structure in the specimen with good visibility to a user, so that diagnostic accuracy can be improved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A microscope system comprising:
an image acquisition unit that acquires a spectral image of a specimen by using a microscope;
a structure specifying unit that specifies an extraction target structure in the specimen;
a display method specifying unit that specifies a display method of the extraction target structure;
a structure extraction unit that extracts an area of the extraction target structure in the spectral image by using a reference spectrum of the extraction target structure on the basis of pixel values of each pixel included in the spectral image;
a display image generator that generates a display image that represents the extraction target structure in the specimen by the display method specified by the display method specifying unit on the basis of an extraction result of the structure extraction unit; and
a display processing unit that performs process for displaying the display image on a display unit.

2. The microscope system according to claim 1, wherein the display image generator generates the display image by replacing pixel values of each pixel extracted by the structure extraction unit as the area of the extraction target structure by a predetermined display color.

3. The microscope system according to claim 2, wherein
the structure extraction unit calculates an accuracy of structure extraction for each pixel on the basis of pixel values of the pixels extracted as the area of the extraction target structure and the reference spectrum of the extraction target structure, and
the display image generator variably sets a predetermined display characteristic value of each of the pixels extracted as the area of the extraction target structure in accordance with the accuracy of the structure extraction of each of the pixels.

4. The microscope system according to claim 3, wherein the display image generator sets a value of brightness or saturation as the display characteristic value.

5. The microscope system according to claim 1, further comprising:
a spectrum component amount acquisition unit that acquires a component amount of a spectrum component of the extraction target structure at a specimen position on a corresponding specimen for each pixel extracted as the area of the extraction target structure,
wherein the display image generator corrects the component amount of the spectrum component of the extraction target structure, and generates an image representing the extraction target structure by the corrected component amount as the display image.

6. The microscope system according to claim 5, wherein the display image generator corrects the component amount of the spectrum component of the extraction target structure to zero, and generates the display image in which the extraction target structure is not displayed.

7. The microscope system according to claim 1, further comprising:
an exclusion target specifying unit that specifies at least one exclusion target pixel to be excluded from the area of the extraction target structure;
an exclusion spectrum setting unit that sets exclusion spectrum information on the basis of a pixel value of the exclusion target pixel; and
an exclusion target extraction unit that extracts a pixel to be excluded from the area of the extraction target structure by using the exclusion spectrum information on the basis of pixel values of each pixel of the area of the extraction target structure.

8. The microscope system according to claim 1, further comprising:
an additional target specifying unit that specifies at least one additional target pixel as the area of the extraction target structure;
an additional spectrum setting unit that sets additional spectrum information on the basis of a pixel value of the additional target pixel; and
an additional target extraction unit that extracts a pixel to be added as the area of the extraction target structure by using the additional spectrum information on the basis of pixel values of each pixel outside the area of the extraction target structure.

9. The microscope system according to claim 1, further comprising:
a spectral characteristic recording unit that records spectral characteristic information for each structure that can be in the specimen,
wherein the structure specifying unit specifies a type of the structure to be the extraction target structure, and
the structure extraction unit extracts a pixel of the extraction target structure in the spectral image by using spectral characteristic information of the extraction target structure recorded in the spectral characteristic recording unit as the reference spectrum.

10. The microscope system according to claim 1, wherein
the structure specifying unit specifies a pixel covering the extraction target structure in the spectral image, and
the structure extraction unit extracts a pixel of the extraction target structure in the spectral image by using a pixel value of the pixel specified by the structure specifying unit as the reference spectrum.

11. The microscope system according to claim 1, further comprising:
a definition information recording unit that records staining type definition information in which a combination of a plurality of structures to be extracted by being associated with a predetermined staining type is set; and
a staining type specifying unit that specifies the staining type,
wherein the structure specifying unit extracts the plurality of structures that are associated with the staining type specified by the staining type specifying unit and recorded in the staining type definition information as the extraction target structure respectively.

12. The microscope system according to claim 1, wherein
the image acquisition unit includes a spectrum image generator for acquiring a plurality of spectral images by capturing images of the specimen for each portion while relatively moving the specimen and an objective lens in a plane perpendicular to an optical axis of the objective lens, and generating a single spectral image by combining the plurality of spectral images.

13. A specimen observation method comprising:
acquiring a spectral image of a specimen by using a microscope;
specifying a predetermined extraction target structure in the specimen;
specifying a display method of the extraction target structure;
extracting an area of the extraction target structure in the spectral image by using a reference spectrum of the extraction target structure on the basis of pixel values of each pixel included in the spectral image;
generating a display image that represents the extraction target structure in the specimen by the specified display method on the basis of the extraction result; and
displaying the display image.

14. A computer program product having a computer readable medium including programmed instructions, wherein the instructions, when executed by a computer, cause the computer to perform:
instructing a microscope to operate and acquiring a spectral image of a specimen;
specifying a predetermined extraction target structure in the specimen;
specifying a display method of the extraction target structure;
extracting an area of the extraction target structure in the spectral image by using a reference spectrum of the extraction target structure on the basis of pixel values of each pixel included in the spectral image;
generating a display image that represents the extraction target structure in the specimen by the specified display method on the basis of the extraction result; and
displaying the display image.
